(19) United States
(12) Patent Application Publication
(10) Pub. No.: US 2026/0313127 A1
(43) Pub. Date: Oct. 8, 2026

(54) INTRA PREDICTION BASED IMAGE CODING METHOD AND APPARATUS THEREFOR

(71) Applicant: LX SEMICON CO., LTD., Daejeon (KR)

(72) Inventors: Jin Wook LEE, Daejeon (KR); Young Jun KIM, Daejeon (KR)

(73) Assignee: LX SEMICON CO., LTD., Daejeon (KR)

(21) Appl. No.: 19/638,710

(22) Filed: Apr. 3, 2026

(30) Foreign Application Priority Data
Apr. 4, 2025 (KR) 10-2025-0044244

(51) Int. Cl. H04N 19/132; H04N 19/11; H04N 19/176; H04N 19/186; H04N 19/70

(52) U.S. Cl. CPC H04N 19/132; H04N 19/11; H04N 19/176; H04N 19/186; H04N 19/70

(57) ABSTRACT

An image decoding method according to an embodiment of the present disclosure comprises obtaining image information including intra prediction related information, deriving an intra prediction mode for a chroma block based on the intra prediction related information, deriving a luma block corresponding to the chroma block, deriving at least one coefficient for the chroma block, and deriving a prediction sample of the chroma block based on the luma block and the at least one coefficient, wherein the at least one coefficient is derived based on neighboring reference samples of the chroma block.

### CROSS REFERENCE TO RELATED APPLICATION

The present application claims priority to Korean Patent Application No. 10-2025-0044244 filed on Apr. 4, 2025, the entire contents of which is incorporated herein for all purposes by this reference.

### BACKGROUND OF THE DISCLOSURE

### Field of the Disclosure

The disclosure relates to an image/video coding method and an image/video coding apparatus.

### Related Art

With an increasing use of multimedia data, the need for efficient video compression technology is rising. Video compression is essential for effectively transmitting high-quality image data within limited network bandwidth. To this end, various video codec technologies have been developed.

Video codec technologies include MPEG-2, H.264/AVC, H.265/HEVC, H.266/VVC, and AOMedia video 1 (AV1), which are expected to be widely utilized in diverse applications, such as Internet-based video streaming, video calls, virtual reality (VR), and augmented reality (AR).

As images/video reach high resolution and high quality, the data size of images/video expands, resulting in a relative increase in the amount of information or bits transmitted. Therefore, when transmitting image data using conventional media, such as wired and wireless broadband lines, or storing image/video data using existing storage media, costs for transmission and storage rise. To provide further improved compression efficiency image quality, there is a growing need for successor codec technologies, such as H.267 and AV2. In other words, high-efficiency image/video compression technology is required to effectively compress, transmit, store, and play high-resolution and high-quality image/video information.

### SUMMARY

According to an embodiment of the disclosure, there are provided a method and an apparatus for enhancing video/image coding efficiency.

According to an embodiment of the disclosure, there are provided a method and an apparatus for providing a next-generation high-quality video service.

According to an embodiment of the disclosure, there are provided a method and an apparatus for providing enhanced performance in a real-time streaming environment.

According to an embodiment of the disclosure, there are provided a method and an apparatus for intra prediction-based video/image coding.

According to an embodiment of the present disclosure, an image decoding method performed by a decoding apparatus is provided. The method includes obtaining image information including intra prediction related information, deriving an intra prediction mode for a chroma block based on the intra prediction related information, deriving a luma block corresponding to the chroma block, deriving at least one coefficient for the chroma block, and deriving a prediction sample of the chroma block based on the luma block and the at least one coefficient, wherein the at least one coefficient is derived based on neighboring reference samples of the chroma block.

According to an embodiment of the present disclosure, an image encoding method performed by an encoding apparatus is provided. The method includes determining an intra prediction mode for a chroma block, deriving a luma block corresponding to the chroma block, deriving at least one coefficient for the chroma block, deriving a prediction sample of the chroma block based on the luma block and the at least one coefficient, and encoding image information including intra prediction mode related information, wherein the at least one coefficient is derived based on neighboring reference samples of the chroma block.

According to an embodiment of the present disclosure, an image decoding apparatus is provided. The image decoding apparatus includes a memory and at least one processor connected to the memory, wherein the at least one processor obtains image information including intra prediction related information through a bitstream, derives an intra prediction mode for a chroma block based on the intra prediction related information, derives a luma block corresponding to the chroma block, derives at least one coefficient for the chroma block, and derives a prediction sample of the chroma block based on the luma block and the at least one coefficient, wherein the at least one coefficient is derived based on neighboring reference samples of the chroma block.

According to an embodiment of the present disclosure, an image encoding apparatus is provided. The image encoding apparatus includes a memory and at least one processor connected to the memory, wherein the at least one processor determines an intra prediction mode for a chroma block, derives a luma block corresponding to the chroma block, derives at least one coefficient for the chroma block, derives a prediction sample of the chroma block based on the luma block and the at least one coefficient, and encodes image information including intra prediction mode related information, wherein the at least one coefficient is derived based on neighboring reference samples of the chroma block.

According to an embodiment of the disclosure, there is provided a method for storing or transmitting video/image data including a bitstream generated by a video/image encoding method according to at least one of embodiments of the disclosure.

According to an embodiment of the disclosure, there is provided an apparatus for storing or transmitting video/image data including a bitstream generated by a video/image encoding method according to at least one of embodiments of the disclosure.

According to an embodiment of the disclosure, there is provided a computer-readable storage medium that stores a program for performing a method according to at least one of the embodiments of the disclosure.

According to an embodiment of the disclosure, there is provided a computer-readable digital storage medium that stores encoded video/image information generated by a video/image encoding method according to at least one of embodiments of the disclosure.

According to an embodiment of the disclosure, there is provided a computer-readable digital storage medium that stores encoded information or encoded video/image information that causes a decoding apparatus to perform a video/image decoding method according to at least one of the embodiments of the disclosure.

According to an embodiment of the disclosure, overall video/image compression efficiency may be enhanced.

According to an embodiment of the disclosure, prediction performance for a current block may be enhanced.

According to an embodiment of the disclosure, signaling efficiency of an intra prediction mode may be enhanced.

According to an embodiment of the disclosure, efficient intra prediction may be performed by performing prediction between color components.

According to an embodiment of the present disclosure, prediction of a chroma sample may be performed using luma samples and reference samples, thereby improving prediction accuracy.

### BRIEF DESCRIPTION OF THE DRAWINGS

FIG. 1 schematically illustrates an example of a video/image coding system to which embodiments of the disclosure are applicable.

FIG. 2 is a diagram schematically illustrating a configuration of a video/image encoding apparatus to which embodiments of the disclosure are applicable.

FIG. 3 is a diagram schematically illustrating a configuration of a video/image decoding apparatus to which embodiments of the disclosure are applicable.

FIG. 4 illustrates examples of an intra prediction-based video/image encoding method.

FIG. 5 illustrates examples of an intra prediction-based video/image decoding method.

FIG. 6 illustrates examples of neighboring reference samples for intra prediction.

FIG. 7 exemplarily illustrates directional intra prediction modes described in the disclosure.

FIG. 8 exemplarily illustrates directional intra prediction modes extended based on an angle delta value.

FIG. 9 illustrates examples of neighboring reference samples of multiple reference lines for intra prediction.

FIG. 10 illustrates an example of multiple lines neighboring reference samples for intra prediction.

FIG. 11 illustrates an example for explaining a relationship between a luma block and a chroma block.

FIG. 12 illustrates an example of a reference sample region used for Mh-CCI prediction.

FIG. 13 illustrates an example of positions of luma samples used in Mh-CCI prediction.

FIG. 14 illustrates another example of positions of luma samples used in Mh-CCI prediction.

FIG. 15 schematically illustrates a video/image encoding method according to embodiment(s) of the disclosure.

FIG. 16 schematically illustrates a video/image decoding method according to embodiment(s) of the disclosure.

### DESCRIPTION OF EXEMPLARY EMBODIMENTS

As the disclosure may have various changes and various embodiments, specific embodiments are illustrated in the drawings and will be described in detail. However, it should be understood that there is no intent to limit embodiments of the disclosure to the specific embodiments. The terminology used herein is for the purpose of describing particular embodiments only and is not intended to limit the technical spirit of the disclosure. As used in the disclosure, singular forms are intended to include plural forms unless the context clearly indicates otherwise. As used herein, the term “and/or” includes any one and all combinations of two or more of the associated listed items. As used herein, the term “include,” “include,” and “have” specify the presence of stated features, numbers, operations, elements, components, and/or combinations thereof, but do not preclude the presence or addition of one or more other features, numbers, operations, elements, components, and/or combinations thereof. In the disclosure, the use of the term “may” in connection with an example or embodiment (e.g., regarding what an example or embodiment may include or implement) signifies that there is at least one example or embodiment in which such a feature is included or implemented, but all examples are not limited thereto and the corresponding feature or configuration may be omitted.

Each component of the drawings described in the disclosure is shown independently for the convenience of explaining distinct characteristic functions, which does not imply that each component is implemented as separate hardware or separate software. For example, two or more of these components may be combined to form a single component, or a single component may be divided into a plurality of components. Embodiments in which components are integrated and/or separated are also included within the scope of the disclosure without departing from the essence of the disclosure.

In the disclosure, “A or B” may mean “only A,” “only B,” or “both A and B.” In other words, “A or B” may be interpreted as “A and/or B” in the disclosure. For example, “A, B, or C” in the disclosure may mean “only A,” “only B,” “only C,” or “any and all combinations of A, B and C.”

A slash (/) or a comma as used herein may mean “and/or.” For example, “A/B” may mean “A and/or B.” Accordingly, “A/B” may mean “only A,” “only B,” or “both A and B.” For example, “A, B, C” may mean “A, B, or C.”

In the disclosure, “at least one of A and B” may mean “only A,” “only B,” or “both A and B.” Further, the expression “at least one of A or B” or “at least one of A and/or B” may be interpreted identically to “at least one of A and B.”

In the disclosure, “at least one of A, B and C” may mean “only A,” “only B,” “only C,” or “any and all combinations of A, B and C.” In addition, “at least one of A, B or C” or “at least one of A, B and/or C” may mean “at least one of A, B and C.”

Parentheses used in the disclosure may mean “for example.” Specifically, when indicated as “prediction (intra prediction),” “intra prediction” may be proposed as an example of “prediction.” In other words, “prediction” in the disclosure is not limited to “intra prediction,” and “intra prediction” may be proposed as an example of “prediction.” Furthermore, even when indicated as “prediction (i.e., intra prediction),” “intra prediction” may be proposed as an example of “prediction.”

In the disclosure, technical features individually explained within a single drawing may be implemented independently, or may be implemented simultaneously.

The disclosure relates to video/image coding. For example, a method/embodiment described in the disclosure may be applied to a method disclosed in an AOMedia Video 2 (AV2) standard. In addition, the method/embodiment disclosed herein may be applied to a method disclosed in an enhanced compression model, an H.267 standard, or a next-generation video/image coding standard (e.g., H.268 and H.269).

In the disclosure, coding may include encoding and/or decoding. In the disclosure, image coding may be used interchangeable with video coding.

In the disclosure, a video may refer to a set of a series of images over time. A frame generally refers to a unit representing a single image at a specific time, and a slice/tile refers to a unit forming a portion of a frame in coding. A slice/tile may include one or more superblock. A single frame may include one or more slices/tiles. A tile may represent a rectangular area of superblocks within a specific tile row and a specific tile column in a frame. A single frame may be divided into two or more subframes.

A pixel or a pel may mean a smallest unit forming one frame (or image). “Sample” may be used as a term corresponding to a pixel. A sample may generally represent a pixel or a pixel value, and may represent only a pixel/pixel value of a luma component or only a pixel/pixel value of a chroma component.

A unit may represent a basic unit of image processing. A unit may include at least one of a specific area of a frame and information related to the area. A single unit may include one luma block and two chroma (e.g., Cb and cr) blocks. A unit may be used interchangeably with terms such as a “block” or an “area” in some cases. In general, an M×N block may include a set (or array) of samples (or a sample array) or transform coefficients in M columns and N rows.

Hereinafter, embodiments of the disclosure will be described in detail with reference to the accompanying drawings. In addition, like reference numerals may be used to indicate like elements throughout the drawings, and redundant descriptions of the like elements may be omitted.

1 schematically illustrates an example of a video/image coding system to which embodiments of the disclosure are applicable.

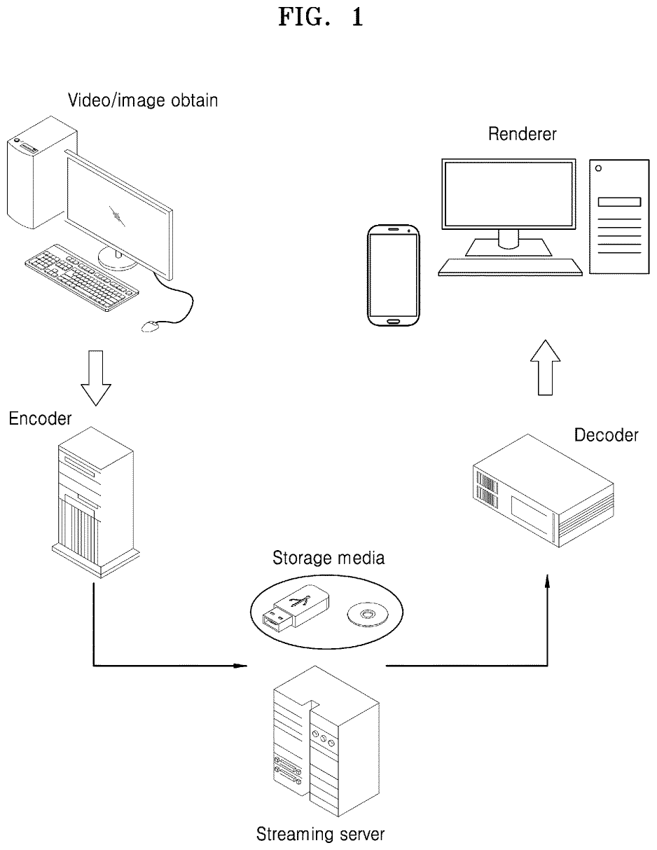

Referring to FIG. 1, the video/image coding system may include a first apparatus (encoding apparatus) and a second apparatus (decoding apparatus). The first apparatus may deliver encoded video/image information or data in a form of a file or streaming to the second apparatus via a digital storage medium or a network.

The video/image coding system may further include a video/image acquisition device and a video/image renderer. The video/image acquisition device may be included in the encoding apparatus, or may be configured as a separate device or an external component. The video/image renderer may be included in the decoding apparatus, or may be configured as a separate device or an external component.

The first apparatus may include a transmitter as an internal component, or as a separate device or an external component.

The second apparatus may include a receiver as an internal component, or as a separate device or an external component.

The encoding apparatus may be referred to as an encoder, and the decoding apparatus may be referred to as a decoder. The transmitter may be included in the encoding apparatus. The receiver may be included in the decoding apparatus. The renderer may include a display, and the display may be configured as a separate device or an external component.

The decoding apparatus and the encoding apparatus to which an embodiment(s) of the disclosure is applied may be included in a multimedia broadcasting transmission/reception device, a mobile communication terminal, a home cinema video device, a digital cinema video device, a surveillance camera, a video conversation device, a real-time communication device such as video communication, a mobile streaming device, a storage medium, a camcorder, a video-on-demand (VoD) service providing device, an over-the-top (OTT) video device, an Internet streaming service providing device, a three-dimensional (3D) video device, a virtual reality (VR) device, an augmented reality (AR) device, a video telephony device, a transportation terminal (e.g., a vehicle terminal (including an autonomous vehicle terminal), an aircraft terminal, and a vessel terminal), and a medical video device, and may be used to process a video signal or a data signal. For example, the over-the-top (OTT) video device may include a game console, a Blu-ray player, an Internet-connected TV, a home theater system, a smartphone, a tablet PC, and a digital video recorder (DVR).

The video/image acquisition device may obtain a video/image source. The video/image acquisition device may obtain a video/image through a process of capturing, synthesizing, or generating a video/image. The video/image acquisition device may include a video/image capture device and/or a video/image generation device. The video/image capture device may include, for example, one or more cameras and a video/image archive including previously captured video/images. The video/image generation device may include, for example, a camcorder, a computer, a tablet PC, and a smartphone, and may (electronically) generate a video/image. For example, a virtual video/image may be generated through a computer, in which case a video/image capture process may be replaced with a process of generating related data. The video/image source may perform a video/image preprocessing process to input an optimized video/image to the encoder.

The encoding apparatus may encode an input video/image. The encoding apparatus may encode an input video/image through an encoding method disclosed herein. The encoding apparatus may perform a series of procedures, such as prediction, transform, and quantization, for compression and coding efficiency. Encoded data (encoded video/image information) may be output in a form of a bitstream.

The transmitter may transmit encoded image/image information or data output in a form of a bitstream to the receiver of the receiving device in a form of a file or streaming through the digital storage medium or the network. The encoded image/image information or data output in the form of the bitstream may be transmitted to the receiver through a streaming server. The digital storage medium may include various storage mediums, such as a USB, an SD, a CD, a DVD, a Blu-ray, an HDD, and an SSD. The transmitter may include an element for generating a media file through a predetermined file format, and may include an element for transmission through a broadcast/communication network. The receiver may receive/extract the bitstream and transmit the received bitstream to the decoding apparatus. In the disclosure, the transmitter may be referred to as a transmitting apparatus, and the receiver may be referred to as a receiving apparatus. As image/video resolution and quality become higher, the raw data size of images/videos is increasing. By obtaining and storing/transmitting a bitstream (or data including the bitstream) generated by an efficient encoding method according to the disclosure, it is possible to increase storage/transmission efficiency and support low-latency/real-time transmission.

The streaming server may temporarily store the bitstream during a process of transmitting or receiving the bitstream. The streaming server transmits multimedia data to a user device, based on a user request via a web server, and the web server serves as an intermediary for informing a user of an available service. When the user requests a desired service from the web server, the web server transmits the request to the streaming server, and the streaming server transmits multimedia data to the user. The content streaming system may include a separate control server, in which case the control server controls a command/response between devices in the content streaming system.

The streaming server may receive content from a media storage and/or the encoding apparatus. For example, when receiving content from the encoding apparatus, the content may be received in real time. In this case, the streaming server may store the bitstream for a certain time to provide a smooth streaming service.

The decoding apparatus may decode the video/image by performing a series of procedures, such as dequantization, inverse transform, and prediction, corresponding to an operation of the encoding apparatus. The decoding apparatus may decode a video/image through a decoding method disclosed herein.

The renderer may render the decoded video/image. The rendered video/image may be displayed on the display.

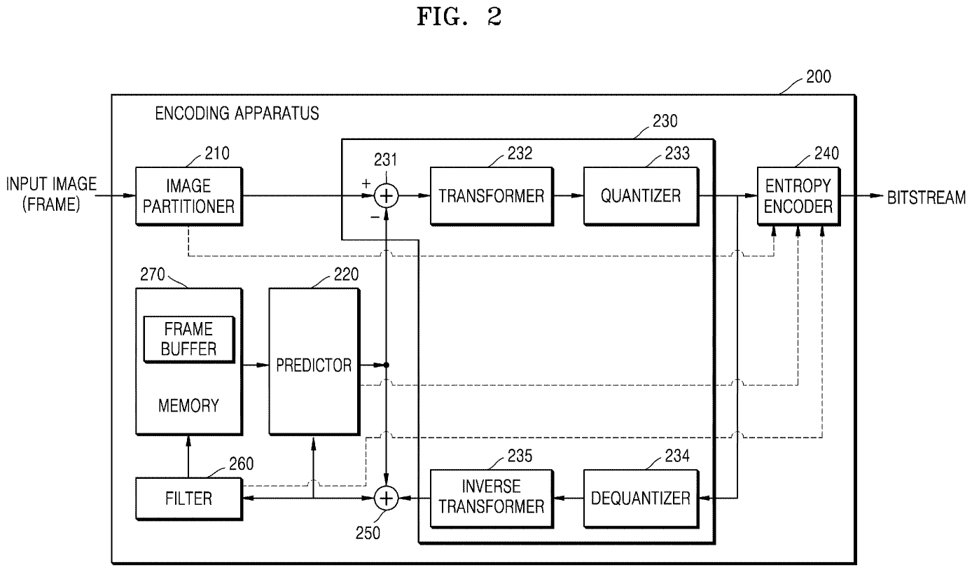

FIG. 2 is a diagram schematically illustrating a configuration of a video/image encoding apparatus to which embodiments of the disclosure are applicable. Hereinafter, an encoding apparatus may include an image encoding apparatus and/or a video encoding apparatus.

Referring to FIG. 2, the encoding apparatus 200 may include an image partitioner 210, a predictor 220, a residual processor 230, and an entropy encoder 240, an adder 250, a filter 260, and a memory 270. The predictor 220 may include an inter predictor and an intra predictor. The residual processor 230 may include a transformer 232, a quantizer 233, a dequantizer 234, and an inverse transformer 235. The residual processor 230 may further include a subtractor 231. The adder 250 may be referred to as a reconstructor or a reconstructed block generator. The image partitioner 210, the predictor 220, the residual processor 230, the entropy encoder 240, the adder 250, and the filter 260 may be configured as at least one hardware component (e.g., an encoder chipset or processor) according to an embodiment. The memory 270 may include a frame buffer, or may be configured as a digital storage medium. The hardware component may further include the memory 270 as an internal/external component.

The image partitioner 210 may partition an input image (or a picture or a frame) input to the encoding apparatus 200 into one or more processing unit. For example, the processing unit may include a superblock or a coding unit (CU). A frame may be partitioned into a plurality tiles. A tile may have a rectangular shape. Uniform or non-uniform tile sizes may be determined on a per-frame basis. In the disclosure, the terms “frame” and “picture” may be used interchangeably. A tile may include an integer number of superblocks. Superblocks within a tile may be coded in raster scan order. A superblock may be partitioned into one or more coding blocks. For example, a superblock may have a size of 128×128 or 64×64 based on a luma component. Alternatively, a superblock may have a size of 256×256 based on the luma component. A superblock may have a dependency only on specific neighboring superblocks. For example, a superblock may have a dependency only on left and/or top neighboring superblocks.

A superblock may be recursively partitioned. For example, a superblock may be derived as a single coding block, or a superblock may be partitioned into coding blocks, based on a binary tree, a ternary tree, or a quad tree. One coding block may be recursively partitioned into a plurality of coding blocks of a deeper depth, based on a binary tree, a ternary tree, or a quad tree. For example, when a coding block is partitioned into PARTITION_N×N, recursive partitioning may be possible. A coding procedure according to the disclosure may be performed based on a final coding block that is no longer partitioned. In this case, a superblock may be directly used as the final coding block, based on coding efficiency according to image characteristics. Alternatively, a coding block may be recursively partitioned into deeper-depth coding blocks as needed so that a coding block with an optimal size may be used as the final coding block. Here, the coding procedure may include procedures such as prediction, transform, and reconstruction, which will be described later. The processing unit may further include a prediction block (PB) or a transform block (TB). In this case, the prediction block or the transform block may be split or partitioned from the final coding block described above. For example, a single transform block of the same size as the coding block may be derived, or a plurality of transform blocks may be derived from the coding block, based on a quad tree or binary tree. The transform block may be recursively partitioned into deeper-depth transform blocks. The prediction block may be a unit for prediction (or for deriving a prediction mode), and the transform block may be a unit for performing a transform, a unit for deriving a transform coefficient, and/or a unit for deriving a residual signal from a transform coefficient. For example, prediction mode derivation for intra prediction may be performed on a coding block basis or a prediction block basis, and prediction sample derivation through an intra prediction procedure may be performed on a transform block basis. A block to be currently processed according to a coding order may be referred to as a current block.

The term “block” may be used interchangeably with the term “unit” or “area” depending on a case. In general, an M×N block may denote an array of samples or transform coefficients arranged in M rows and N columns. A sample may generally denote a pixel or a pixel value, and may represent only a pixel/pixel value of a luma component or only a pixel/pixel value of a chroma component. A “sample” may be used as a term corresponding to a pixel or pel of a frame (or image).

The encoding apparatus 200 may generate a residual signal (residual signal, residual block, or residual sample array) by subtracting a prediction signal (predicted block or predicted sample array) output from the predictor from an input image signal (original block or original sample array), and the generated residual signal is transmitted to the transformer 232. In this case, as illustrated, a component for subtracting the prediction signal (predicted block or predicted sample array) from the input image signal (original block or original sample array) in the encoder 200 may be referred to as the subtractor 231. The predictor may perform prediction on a processing target block (hereinafter, referred to as a current block), and may generate a predicted block including prediction samples for the current block. The predictor may determine whether intra prediction or inter prediction is applied on a current block or coding block basis. The predictor may generate various pieces of information about prediction, such as prediction mode information, and may transmit the generated information to the entropy encoder 240, as described below in a description of each prediction mode. The information about prediction may be encoded by the entropy encoder 240 and output in a form of a bitstream.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block (colblock), and the reference frame including the temporal neighboring block may also be referred to as a co-located frame (colframe). For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or top boundary of the current block, and the local warp mode may apply an affine model in addition to translational motion compensation.

A motion vector may be derived based on various prediction modes. For example, in an NEWMV mode, a motion vector of the current block may be indicated based on a motion vector of a reference stack and a motion vector difference. If needed, in the NEWMV mode, the motion vector of the current block may be indicated based on the motion vector difference without the motion vector of the reference stack. Information about the motion vector difference may be generated by the encoding apparatus and signaled to the decoding apparatus. A ZEROMV mode may indicate that a zero vector or a default vector is used as the motion vector of the current block. An REFMV mode may indicate that a motion vector of the motion information stack is used as the motion vector of the current block. However, these designations are only examples, and the motion vector of the current block may be indicated by various other names. For example, a GLOBALMV mode may indicate that global motion information is used for the current block. For example, an NEARSTMV mode may indicate that a first candidate (candidate at index 0) of the motion information stack is used for the current block. For example, an NEARMV mode may indicate that a specific candidate (indicated by refMVidx) of the motion information stack is used for the current block. However, the above mode names are examples, and other names, such as mode 1 and mode 2, may be used if needed.

When compound prediction is applied, inter prediction may be performed using both reference frame lists L0 and L1. In this case, a motion vector for an L0 direction and a motion vector for an L1 direction may be derived. Furthermore, an L0 reference frame for the L0 direction and an L1 reference frame for the L1 direction may be derived. If needed, a first motion vector and a second motion vector may be used instead of an L0 motion vector and an L1 motion vector, respectively. If needed, a first reference frame and a second reference frame may be used instead of the L0 reference frame and the L1 reference frame, respectively.

The predictor 220 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within the current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The prediction signal generated by the predictor 220 may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a Karhunen-Loeve transform (KLT), a graph-based transform (GBT), or a conditionally non-linear transform (CNT). Further, the transform technique may include, for example, a DCT, asymmetric discrete sine transform (ADST), a flipped ADST (FLIPADST), an identity transform (IDTX), a Walsh-Hadamard transform (WHT), a V_DCT, and an H_DCT. The DCT is one of the most widely used transformation techniques in image compression, primarily transforming image signals into a frequency domain to concentrate energy into low-frequency components. The ADST is similar to the DCT, but is designed to smoothly connect signals at block boundaries. The FLIPADST is a modified version of the ADST that applies a transform in a reversed direction, enabling more efficient signal compression for a specific block pattern. The IDTX is an identity transformation method that maintains a signal without any transformation. The identity transform may be applied to either a vertical transform or a horizontal transform, or both. For example, when a transformation method is specified for only one of the vertical and horizontal transforms, the identity transform may be implicitly applied to the other transform. The WHT is a linear transform similar to a discrete Fourier transform (DFT) or discrete cosine transform (DCT), representing signals or data by transforming the same into a different basis. The WHT may use an orthogonal basis matrix including+1 and −1 instead of using a trigonometric function (sine and cosine). The V_DCT and the H_DCT indicate that the DCT transform is performed in the vertical direction of a block and the DCT transform is performed in the horizontal direction of the block, respectively. For example, for a simple block, the DCT may be used to increase a compression ratio, while the ADST or FLIPADST may be used when smooth transitions are required at boundaries. For a block where a signal remains nearly unchanged, the IDTX may be applied.

The quantizer 233 may quantize the transform coefficients and transmit the same to the entropy encoder 240, and the entropy encoder 240 may encode a quantized signal (information about the quantized transform coefficients) and output the encoded signal as a bitstream. The information about the quantized transform coefficients may be referred to as residual information. The quantizer 233 may rearrange the quantized transform coefficients in a block form into a one-dimensional vector form, based on a coefficient scan order, and may generate the information about the transform coefficients, based on the quantized transform coefficients in the one-dimensional vector form. The entropy encoder 240 may perform various encoding methods, for example, a cumulative distribution function and context-adaptive binary arithmetic coding (CABAC). The CDF is a method of storing cumulative values of a probability distribution, allowing symbols to be represented with fewer bits compared to storing probabilities directly. Within the CDF, symbol probabilities may be adaptively adjusted based on context. The entropy encoder 240 may encode information (e.g., values of syntax elements) necessary for video/image reconstruction other than the quantized transform coefficients together or separately. The encoded information (e.g., encoded video/image information) may be packetized on an open bitstream unit (OBU) basis in a form of a bitstream and be transmitted or stored. The video/image information may further include information commonly applied to a specific range, such as a tile header, a frame header, and a sequence header. In the disclosure, information and/or syntax elements transmitted/signaled from the encoding apparatus to the decoding apparatus may be included in the video/image information. The video/image information may be encoded through the foregoing encoding procedure and included in the bitstream. The bitstream may be transmitted through a network, or may be stored in a digital storage medium. The network may include a broadcasting network and/or a communication network, and the digital storage medium may include various storage media, such as a USB, an SD, a CD, a DVD, a Blu-ray, an HDD, and an SSD. A transmitter (not shown) and/or a storage (not shown) for transmitting and/or storing a signal output from the entropy encoder 240 may be configured as internal/external elements of the encoding apparatus 200, or the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 may add the reconstructed residual signal to the prediction signal output from the predictor to generate a reconstructed signal (reconstructed frame, reconstructed block, or reconstructed sample array). When there is no residual for the processing target block, such as when a skip mode is applied, the predicted block may be used as a reconstructed block. The adder 250 may be referred to as a reconstructor or a reconstructed block generator. The generated reconstructed signal may be used for intra prediction of a next processing target block in the current frame, or may be used for inter prediction of a next frame after being filtered as described below.

The filter 260 may improve subjective/objective image quality by applying filtering to the reconstructed signal. For example, the filter 260 may generate a modified reconstructed frame by applying various filtering methods to the reconstructed frame, and may store the modified reconstructed frame in the memory 270, specifically, in the frame buffer of the memory 270. The various filtering methods may include, for example, deblocking filtering, a sample adaptive offset, an adaptive loop filter, and a bilateral filter. The filter 260 may generate information related to the filtering, and may transmit the generated information to the entropy encoder 240. The information related to the filtering may be encoded by the entropy encoder 240 and output in a form of a bitstream.

The modified reconstructed frame transmitted to the memory 270 may be used as a reference frame in the inter predictor. When inter prediction is applied via the modified reconstructed frame, the encoding apparatus may avoid a prediction mismatch between the encoding apparatus 200 and the decoding apparatus, and may improve encoding efficiency may be improved.

The memory 270 may store the modified reconstructed frame for use as the reference frame in the inter predictor. The memory 270 may store motion information about a block from which motion information in the current frame is derived (or encoded) and/or motion information about blocks in a frame already reconstructed. The stored motion information may be transmitted to the inter predictor to be utilized as motion information about the spatial neighboring block or motion information about the temporal neighboring block. The memory 270 may store reconstructed samples of reconstructed blocks in the current frame, and may transmit the reconstructed samples to the intra predictor.

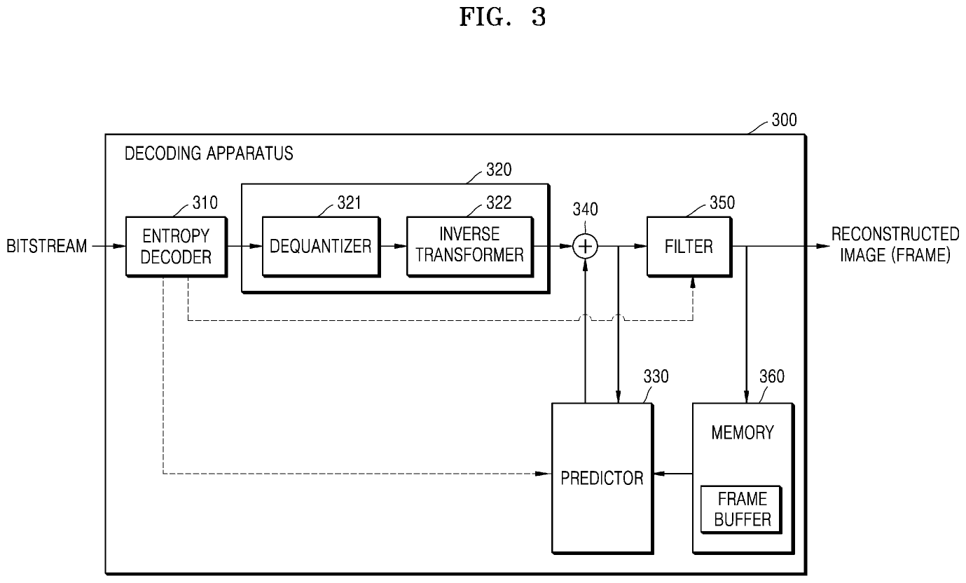

FIG. 3 is a diagram schematically illustrating a configuration of a video/image decoding apparatus to which embodiments of the disclosure are applicable. Hereinafter, a decoding apparatus may include an image decoding apparatus and/or a video decoding apparatus.

Referring to FIG. 3, the decoding apparatus 300 may include an entropy decoder 310, a residual processor 320, a predictor 330, an adder 340, a filter 350, and a memory 360. The predictor 330 may include an inter predictor and an intra predictor. The residual processor 320 may include a dequantizer 321 and an inverse transformer 322. The entropy decoder 310, the residual processor 320, the predictor 330, the adder 340, and the filter 350 may be configured as a single hardware component (e.g., a decoder chipset or processor) according to an embodiment. The memory 360 may include a frame buffer, and may be configured as a digital storage medium. The hardware component may further include the memory 360 as an internal/external component.

When a bitstream including video/image information is input, the decoding apparatus 300 may reconstruct an image according to a process in which the video/image information is processed in the encoding apparatus of FIG. 2. For example, the decoding apparatus 300 may derive units/blocks, based on block partition-related information obtained from the bitstream. The decoding apparatus 300 may perform decoding using a processing unit applied to the encoding apparatus. Therefore, the processing unit for decoding may be, for example, a superblock or a coding unit, and a coding unit may be partitioned from a superblock according to a quad-tree structure, a binary-tree structure, and/or a ternary-tree structure. One or more prediction blocks or transform units may be derived from a coding unit. A reconstructed image signal decoded and output by the decoding apparatus 300 may be reproduced via a reproducing apparatus.

The decoding apparatus 300 may receive a signal output from the encoding apparatus in a form of a bitstream, and the received signal may be decoded by the entropy decoder 310. For example, the entropy decoder 310 may parse the bitstream to derive information (e.g., video/image information) necessary for image reconstruction (or frame reconstruction). The video/image information may further include information commonly applied to a specific range, such as a tile header, a frame header, and a sequence header. The decoding apparatus may decode a frame, based on the header information. In the disclosure, signaled/received information and/or syntax elements to be described below may be decoded through the decoding procedure and may be obtained from the bitstream. For example, the entropy decoder 310 may decode the information in the bitstream, based on a coding method, such as a CDF and CABAC, and may output a value of a syntax element required for image reconstruction and a quantized value of a transform coefficient for a residual. More specifically, the CDF-based coding method may include a procedure of storing a probability distribution of symbols in a form of a CDF, selecting an appropriate CDF by analyzing context of a current block, encoding symbols at an encoder side, based on the CDF, and reconstructing syntax elements/information using the same CDF at a decoder side. The CABAC method may determine a context model by using a target syntax element/information and coding information about neighboring and coding target blocks or information about a symbol/bin coded in a previous stage, generate a bit string by predicting an occurrence probability of a bin according to the determined context model and performing arithmetic encoding on the bin at the encoder side, and generate a symbol corresponding to a value of each syntax element by predicting an occurrence probability of a bin according to the determined context model and performing arithmetic decoding on the bin at the decoder side. Here, after determining the context model, the context model may be updated using information about a coded symbol/bin for a context model of a next symbol/bin. Prediction-related information among the information decoded by the entropy decoder 310 may be provided to the predictor 330, and a residual value obtained through entropy decoding in the entropy decoder 310, that is, quantized transform coefficients and related parameter information, may be input to the residual processor 320. The residual processor 320 may derive a residual signal (residual block, residual samples, or residual sample array). Filtering-related information among the information decoded by the entropy decoder 310 may be provided to the filter 350. A receiver (not shown) for receiving a signal output from the encoding apparatus may be further configured as an internal/external element of the decoding apparatus 300, or the receiver may be a component of the entropy decoder 310. The decoding apparatus according to the disclosure may be referred to as a video/image/frame decoding apparatus, and may be divided into an information decoder (video/image/frame information decoder) and a sample decoder (video/image/frame sample decoder). The information decoder may include the entropy decoder 310, and the sample decoder may include at least one of the dequantizer 321, the inverse transformer 322, the adder 340, the filter 350, the memory 360, and the predictor 330.

The dequantizer 321 may dequantize the quantized transform coefficients to output transform coefficients. The dequantizer 321 may rearrange the quantized transform coefficients in a two-dimensional block form. In this case, the rearrangement may be performed based on a coefficient scan order executed in the encoding apparatus. The dequantizer 321 may perform dequantization on the quantized transform coefficients using a quantization parameter (e.g., quantization step size information), and obtain the transform coefficients.

The inverse transformer 322 inversely transforms the transform coefficients to acquire a residual signal (residual block or residual sample array).

The predictor may perform prediction of the current block, and may generate a predicted block including prediction samples of the current block. The predictor may determine whether intra prediction is applied or inter prediction is applied to the current block, based on the prediction-related information output from the entropy decoder 310, and determine a specific intra/inter prediction mode.

The predictor 330 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within a current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector. Intra prediction may be performed based on various prediction modes, and the prediction-related information obtainable through the bitstream may include information indicating an intra prediction mode for the current block.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block, and the reference frame including the temporal neighboring block may also be referred to as a co-located frame. For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or top boundary of the current block, and the local warp mode may apply an affine model in addition to translational motion compensation. Inter prediction may be performed based on various prediction modes, and the prediction-related information obtainable through the bitstream may include information indicating an inter prediction mode for the current block. For example, the inter predictor may configure a motion information stack, based on neighboring blocks, and may derive a motion vector and/or a reference frame index of the current block, based on received candidate selection information (e.g., a reference motion vector index and/or a reference frame index).

The adder 340 may add the obtained residual signal to the prediction signal (predicted block or prediction same array) output from the predictor 330 to generate a reconstructed signal (reconstructed frame, reconstructed block, or reconstructed sample array). When there is no residual for the processing target block, such as when a skip mode is applied, the predicted block may be used as a reconstructed block.

The adder 340 may be referred to as a reconstructor or a reconstructed block generator. The generated reconstructed signal may be used for intra prediction of a next processing target block in the current frame, or may be output or used for inter prediction of a next frame after being filtered as described below.

The filter 350 may improve subjective/objective image quality by applying filtering to the reconstructed signal. For example, the filter 350 may generate a modified reconstructed frame by applying various filtering methods to the reconstructed frame, and may transmit the modified reconstructed frame to the memory 360, specifically, to the frame buffer of the memory 360. The various filtering methods may include, for example, deblocking filtering, a sample adaptive offset, an adaptive loop filter, and a bilateral filter.

The (modified) reconstructed frame stored in the memory 360 may be used as a reference frame in the inter predictor. The memory 360 may store motion information about a block from which motion information in the current frame is derived (or decoded) and/or motion information about blocks in a frame already reconstructed. The stored motion information may be transmitted to the inter predictor to be utilized as motion information about the spatial neighboring block or motion information about the temporal neighboring block. The memory 360 may store reconstructed samples of reconstructed blocks in the current frame, and may transmit the reconstructed samples to the intra predictor.

In this specification, the embodiments described for each component of the encoding apparatus 200 may also be applied equally or correspondingly to the corresponding components of the decoding apparatus 300.

As described above, in performing image coding, prediction is conducted to increase compression efficiency. Through the prediction, a predicted block including prediction samples for a current block, which is a coding target block, may be generated. The predicted block includes the prediction samples in a spatial domain (or pixel domain). The predicted block is derived identically in an encoding apparatus and a decoding apparatus, and the encoding apparatus may enhance image coding efficiency by signaling information about a residual between an original block and the predicted block(residual information), rather than an original sample value of the original block, to the decoding apparatus. The decoding apparatus may derive a residual block including residual samples, based on the residual information, may generate a reconstructed block including reconstructed samples by combining the residual block and the predicted block, and may generate a reconstructed frame including the reconstructed blocks.

The residual information may be generated through transform and quantization procedures. For example, the encoding apparatus may derive a residual block between the original block and the predicted block, may perform a transform procedure on residual samples (a residual sample array) included in the residual block to derive transform coefficients, and may perform a quantization procedure on the transform coefficients to derive quantized transform coefficients, and may signal the related residual information to the decoding apparatus (via a bitstream). The residual information may include information, such as value information and position information about the quantized transform coefficients, a transform technique, a transform kernel, and a quantization parameter. The decoding apparatus may perform a dequantization/inverse transform procedure based on the residual information to derive the residual samples (or residual block). The decoding apparatus may generate a reconstructed frame, based on the predicted block and the residual block. The encoding apparatus may perform a dequantization/inverse transform on the quantized transform coefficients to derive the residual block for reference in inter prediction of a subsequent frame, and may generate a reconstructed frame, based on the residual block.

In the disclosure, at least one of quantization/dequantization and/or transform/inverse transform may be omitted. When the quantization/dequantization is omitted, the quantized transform coefficients may be referred to as transform coefficients. When the transform/inverse transform is omitted, the transform coefficients may be referred to as coefficients or residual coefficients, or may still be referred to as transform coefficients for consistency in expression.

Further, in the disclosure, a quantized transform coefficient and a transform coefficient may be referred to as a transform coefficient and a scaled transform coefficient, respectively. In this case, residual information may include information about a transform coefficient(s), and the information about the transform coefficient(s) may be signaled via residual coding syntax. Transform coefficients may be derived based on the residual information (or information about the transform coefficient(s)), and scaled transform coefficients may be derived through inverse transform (scaling) of the transform coefficients. Residual samples may be derived based on inverse transform (transform) of the scaled transform coefficients. These details may be equally applied or described in other parts of the disclosure.

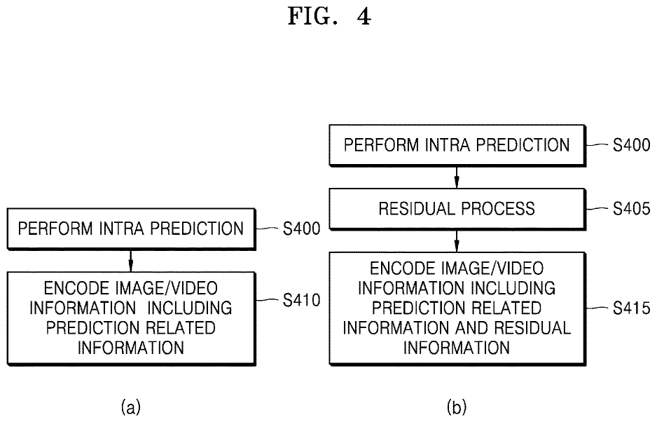

FIG. 4 illustrates examples of an intra prediction-based video/image encoding method.

Referring to FIG. 4, S400 may be performed by a predictor of an encoding apparatus, S405 may be performed by a residual processor of the encoding apparatus, and S410 or S415 may be performed by an entropy encoder of the encoding apparatus. Specifically, the prediction-related information may be derived by the predictor and encoded by the entropy encoder. The residual information may be derived by the residual processor and encoded by the entropy encoder. The residual information is information regarding the residual samples. The residual information may include information regarding quantized transform coefficients for the residual samples. As described above, the residual samples may be derived as transform coefficients through a transformer of the encoding apparatus, and the transform coefficients may be derived as quantized transform coefficients through a quantizer. Information regarding the quantized transform coefficients may be encoded in the entropy encoder through a residual coding procedure.

The encoding apparatus performs intra prediction for a current block (S400). The encoding apparatus may derive an intra prediction mode/type for the current block, derive reference samples of the current block, and generate prediction samples in the current block based on the intra prediction mode/type and the reference samples. Here, a procedure of determining the intra prediction mode/type, a procedure of deriving neighboring reference samples, and a procedure of generating the prediction samples may be performed simultaneously, or one procedure may be performed before another procedure. The encoding apparatus may determine a mode/type to be applied to the current block from among a plurality of intra prediction modes/types. The encoding apparatus may compare RD costs for the intra prediction modes/types and determine an optimal intra prediction mode/type for the current block.

Meanwhile, the encoding apparatus may perform a prediction sample filtering procedure. The prediction sample filtering may be referred to as post-filtering. According to the prediction sample filtering procedure, some or all of the prediction samples may be filtered. In some cases, the prediction sample filtering procedure may be omitted.

The encoding apparatus generates residual samples for the current block based on the prediction samples (S405). The encoding apparatus may derive the residual samples by comparing the prediction samples with original samples of the current block on a sample-by-sample basis.

The encoding apparatus may encode video/image information including information regarding the intra prediction (prediction-related information) and/or information regarding the residual samples (residual information) (S410 or S415). The prediction-related information may include the intra prediction mode information and the intra prediction type information. The encoding apparatus may output the encoded video/image information in the form of a bitstream. The output bitstream may be transmitted to a decoding apparatus through a storage medium or a network.

The residual information may include residual coding syntax elements. The encoding apparatus may derive quantized transform coefficients by transforming and quantizing the residual samples. The residual information may include information regarding the quantized transform coefficients.

Meanwhile, as described above, the encoding apparatus may generate a reconstructed picture (including reconstructed samples and reconstructed blocks). For this purpose, the encoding apparatus may derive (modified) residual samples by performing dequantization and inverse transform on the quantized transform coefficients. The reason for performing dequantization and inverse transform on the residual samples after transform and quantization is to derive residual samples identical to the residual samples derived in the decoding apparatus, as described above. The encoding apparatus may generate a reconstructed block including reconstructed samples for the current block based on the prediction samples and the (modified) residual samples. A reconstructed picture for the current picture may be generated based on the reconstructed block. As described above, in-loop filtering procedures and the like may be further applied to the reconstructed picture.

The decoding apparatus may perform operations corresponding to the operations performed by the encoding apparatus. A video/image decoding procedure based on intra prediction may include, for example, the following.

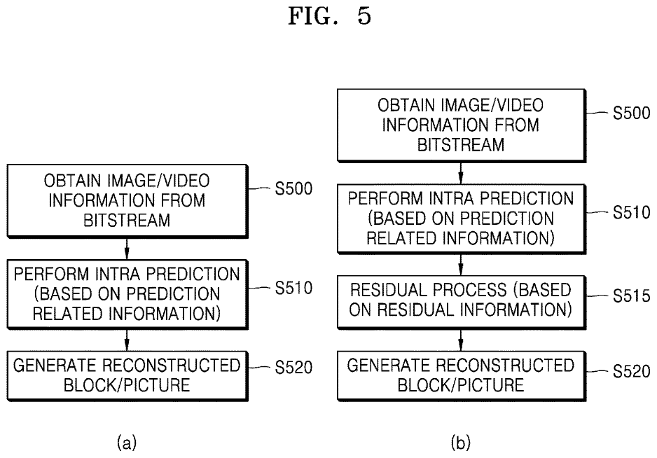

FIG. 5 illustrates examples of an intra prediction-based video/image decoding method.

Referring to FIG. 5, S500 may be performed by an entropy decoder of a decoding apparatus, S510 may be performed by a predictor of the decoding apparatus, S515 may be performed by a residual processor of the decoding apparatus, and S520 may be performed by an adder or a reconstructor of the decoding apparatus.

Specifically, the decoding apparatus obtains video/image information from a bitstream (S500). The video/image information may include prediction-related information and/or residual information.

The decoding apparatus performs intra prediction based on the prediction-related information (S510). The decoding apparatus may derive an intra prediction mode/type for a current block based on the prediction-related information, derive reference samples of the current block, and generate prediction samples in the current block based on the intra prediction mode/type and the reference samples. In this case, the decoding apparatus may perform a prediction sample filtering procedure. The prediction sample filtering may be referred to as post-filtering. According to the prediction sample filtering procedure, some or all of the prediction samples may be filtered. In some cases, the prediction sample filtering procedure may be omitted.

The decoding apparatus performs residual process based on the residual information (S515). The decoding apparatus may derive residual samples for the current block based on the residual information. Specifically, a dequantizer of the residual processor may derive transform coefficients by performing dequantization based on quantized transform coefficients derived based on the residual information, and an inverse transformer of the residual processor may derive residual samples for the current block by performing inverse transform on the transform coefficients.

The decoding apparatus generates a reconstructed block/picture (S520). The decoding apparatus may generate reconstructed samples for the current block based on the prediction samples and/or the residual samples and derive a reconstructed block including the reconstructed samples. A reconstructed picture for the current picture may be generated based on the reconstructed block. As described above, in-loop filtering procedures and the like may be further applied to the reconstructed picture.

The intra prediction mode information and/or the intra prediction type information may be encoded/decoded through a binarization and coding method described in the disclosure. For example, the intra prediction mode information and/or the intra prediction type information may be binarized through fixed-length binarization, truncated Rice binarization, truncated unary binarization, or the like. For example, the intra prediction mode information and/or the intra prediction type information may be encoded/decoded through entropy coding (e.g., CABAC, CAVLC).

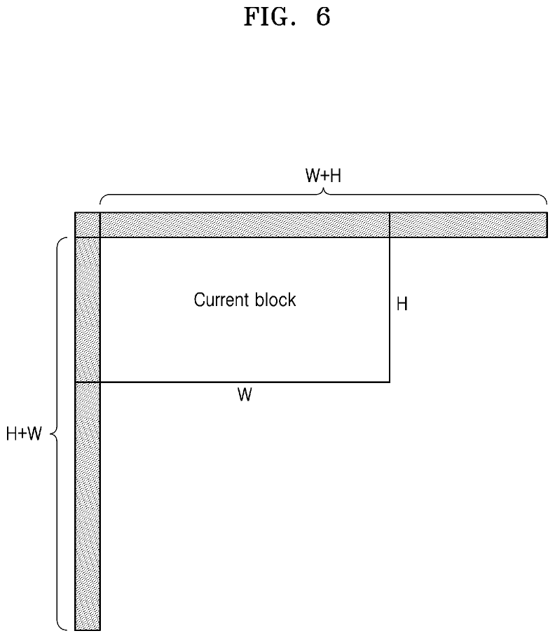

FIG. 6 illustrates examples of neighboring reference samples for intra prediction.

Referring to FIG. 6, neighboring reference samples of the current block may include W+H or more top reference samples, H+W or more left reference samples, and one or more top-left reference samples. The neighboring reference samples may include top neighboring reference samples (A), top-right reference samples (AR), left neighboring reference samples (L), bottom-left reference samples (BL), and a top-left reference sample (AL).

For example, the top reference samples may be represented as AboveRow[i], where i may have a value of 0 to W+H−1. When the top reference samples are unavailable, if the left reference samples are available, one of the left reference samples may be used as a sample value for the top reference samples. Specifically, for example, the unavailable top reference samples may be padded or substituted to be identical to an uppermost reference sample among the left neighboring reference samples. That is, the unavailable top reference samples may be padded or substituted to be identical to a left reference sample at a coordinate (x−1, y). Here, (x, y) may represent the position of the top-left sample of the current block (e.g., a coding block or transform block). When the top reference samples are unavailable and the left reference samples are also unavailable, the top reference samples may be padded or substituted with a default value derived based on a predetermined bit depth. The default value may be set to, for example, (1<<(BitDepth−1))−1. Alternatively, the unavailable top reference samples may be padded or substituted to be identical to the top-left reference sample.

When the top reference samples are available, reconstructed sample values of the top reference samples are basically used as values of the top reference samples. When the top reference samples are available, a first parameter may be determined. The first parameter may be determined as, for example, x+2W−1. When H>W, the reconstructed sample values are not used for specific top reference samples having an x-coordinate greater than the first parameter, and a value of a top reference sample having an x-coordinate of the first parameter is copied (padded or substituted) for the specific top reference samples. That is, for the specific top reference samples, a value of a top reference sample at a coordinate (first parameter, y-1) may be copied (padded or substituted). Alternatively, when H>W, a value of a 2W-th top reference sample may be copied (padded or substituted) for top reference samples after the 2W-th top reference sample.

The left reference samples may be represented, for example, as LeftCol[i], where i may have a value of 0 to W+H−1. When the left samples are unavailable, if the top reference samples are available, one of the top reference samples may be used as a sample value for the left reference samples. Specifically, for example, the unavailable left reference samples may be padded or substituted to be identical to a leftmost reference sample among the top neighboring reference samples. That is, the unavailable left reference samples may be padded or substituted to be identical to a top reference sample at a coordinate (x, y−1). Here, (x, y) may represent the position of the top-left sample of the current block (e.g., a coding block or transform block).

When the left reference samples are unavailable and the top reference samples are also unavailable, the left reference samples may be padded or substituted with a default value derived based on a predetermined bit depth. The default value may be set to, for example, (1<<(BitDepth−1))−1. Alternatively, the unavailable left reference samples may be padded or substituted to be identical to the top-left reference sample.

When the left reference samples are available, reconstructed sample values of the left reference samples are basically used as values of the left reference samples. When the left reference samples are available, a second parameter may be determined. The second parameter may be determined as, for example, x+2H−1. When W>H, the reconstructed sample values are not used for specific left reference samples having a y-coordinate greater than the second parameter, and a value of a left reference sample having a y-coordinate of the second parameter is copied (padded or substituted) for the specific left reference samples. That is, for the specific left reference samples, a value of a left reference sample at a coordinate (x−1, second parameter) may be copied (padded or substituted). Alternatively, when W>H, a value of a 2H-th left reference sample may be copied (padded or substituted) for left reference samples after the 2H-th left reference sample.

The top-left reference sample includes a reference sample at a coordinate (x−1, y−1), and may be represented as AboveRow[−1] or LeftCol[−1] for convenience. When the top-left reference sample is available, a reconstructed sample value of the reference sample is used. When the top-left reference sample is unavailable, a value of an available left reference sample at a coordinate (x−1, y) or an available top reference sample at a coordinate (x, y−1) may be copied (padded or substituted). When the top-left reference sample is unavailable and both the left reference sample and top reference sample are unavailable, the top-left reference samples may be padded or substituted with a default value derived based on a given bit depth. The default value may be set to, for example, (1<<(BitDepth−1))−1.

For example, the coding apparatus may generate the prediction samples, based on the intra prediction mode/type and the reference samples. The coding apparatus may derive a reference sample according to the intra prediction mode of the current block among the reference samples of the current block, and may derive a prediction sample of the current block, based on the reference sample.

The intra prediction mode may be signaled based on the intra prediction mode information, and the intra prediction type may be signaled based on the intra prediction type information. The intra prediction mode information and/or the intra prediction type information may be encoded/decoded through binarization and coding methods described in the disclosure. For example, the intra prediction mode information and/or the intra prediction type information may be encoded/decoded through various coding methods (e.g., CDF and CABAC).

For example, the intra prediction mode may include the following intra prediction modes. The intra prediction modes in Table 1 may be intra prediction modes for a luma component or a chroma component.

TABLE 1

| Intra prediction | |
|---|---|
| mode number | Classification |
| 0 | DC intra prediction mode |
| 1~8 | Directional intra prediction modes |
| 9~11 | SMOOTH intra prediction modes |
| 12 | PAETH intra prediction mode |

In a DC intra prediction mode, the current block may be predicted using an average value of the neighboring reference samples of the current block. The DC intra prediction mode may be referred to as a DC prediction mode or DC mode. In directional intra prediction modes, prediction may be performed using a value of a reference sample located in a specific direction based on a sample position within the current block. The directional intra prediction modes may basically include a horizontal mode, a horizontal-left-down (D203) mode, a horizontal-left-up (D157) mode, a diagonal-left-up (D135) mode, a vertical mode, a vertical-left-up (D133) mode, a vertical-right-up (D67) mode, and a diagonal-right-up (D45) mode. Further, an angle delta value may be additionally signaled to indicate a more detailed intra prediction direction. In SMOOTH intra prediction modes, prediction may be performed by interpolating values of the neighboring reference samples of the current block. In this case, vertical interpolation, horizontal interpolation, or both vertical interpolation and horizontal interpolation may be performed depending on a mode. In a PAETH intra prediction mode, prediction may be performed using the top-left reference sample, a left reference sample, and a top reference sample of the current block. In this case, prediction may be performed using a difference between the left reference samples and the top-left reference sample and a difference between the top reference sample and the top-left reference sample.

Meanwhile, a CFL (chroma from luma) intra prediction mode for a chroma block may be further considered. The intra prediction modes in Table 2 may be intra prediction modes for a chroma component.

TABLE 2

| Intra prediction | |
|---|---|
| mode number | Classification |
| 0 | DC intra prediction mode |
| 1~8 | Directional intra prediction modes |
| 9~11 | SMOOTH intra prediction modes |
| 12 | PAETH intra prediction mode |
| 13 | CFL intra prediction mode |

In the CFL intra prediction mode, a chroma block may be predicted based on a linear or nonlinear model using a reconstructed luma block. For example, the CFL intra prediction mode may be assigned intra prediction mode number 13.

As described above, a plurality of directional intra prediction modes may be considered to improve intra prediction performance.

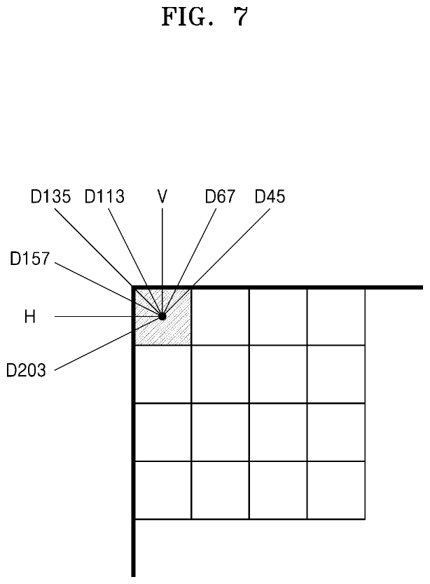

FIG. 7 illustrates directional intra prediction modes described in the disclosure.

Referring to FIG. 7, the directional intra prediction modes may basically include a horizontal mode, a horizontal-left-down (D203) mode, a horizontal-left-up (D157) mode, a diagonal-left-up (D135) mode, a vertical mode, a vertical-left-up (D133) mode, a vertical-right-up (D67) mode, and a diagonal-right-up (D45) mode. Further, an angle delta value may be additionally signaled to indicate a more detailed intra prediction direction. When a directional intra prediction mode is applied, a prediction sample may be generated using a reference sample located in an intra prediction direction relative to the position of a target sample within a current block. However, this example is merely for illustration, and more directional prediction modes may be used.

Further, as described above, an angle delta value may be additionally signaled to indicate a more detailed intra prediction direction.

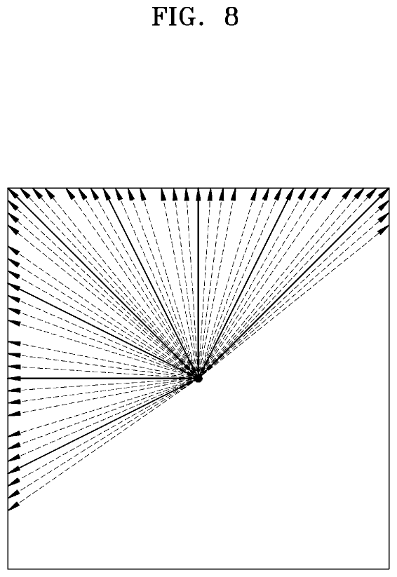

FIG. 8 illustrates directional intra prediction modes extended based on an angle delta value.

Referring to FIG. 8, information indicating one of n angle deltas (or offsets) may be signaled based on the aforementioned basic intra prediction directions, such as the horizontal mode, the horizontal-left-down (D203) mode, the horizontal-left-up (D157) mode, the diagonal-left-up (D135) mode, the vertical mode, the vertical-left-up (D133) mode, the vertical-right-up (D67) mode, and the diagonal-right-up (D45) mode. Here, n is, for example, 6. That is, based on the basic intra prediction directions, three angle delta values may exist on each of the left and right sides in addition to a 0-degree default. In other words, each basic intra prediction direction may have a total of eight detailed intra prediction directions.

For example, information regarding an angle delta may be signaled based on a block size. For example, when an intra prediction mode of a current block is a directional intra prediction mode and the width and/or height of the current block is 8 or greater, information regarding an angle delta may be additionally signaled.

For example, when the intra prediction mode of the current block is a directional intra prediction, an angle delta flag may be signaled first, and angle delta index information may be signaled if a value of the angle delta flag is 1. The angle delta index information may indicate one of the aforementioned angle deltas. When the value of the angle delta flag is 0, signaling of the angle delta index information may be omitted.

Meanwhile, neighboring reference samples for intra prediction may be selected based on MRLS, which is a prediction type in which intra prediction is performed by selecting some of a plurality of reference sample lines for intra prediction. In this case, the neighboring reference samples may include a plurality of rows of top neighboring reference samples and a plurality of columns of left neighboring reference samples.

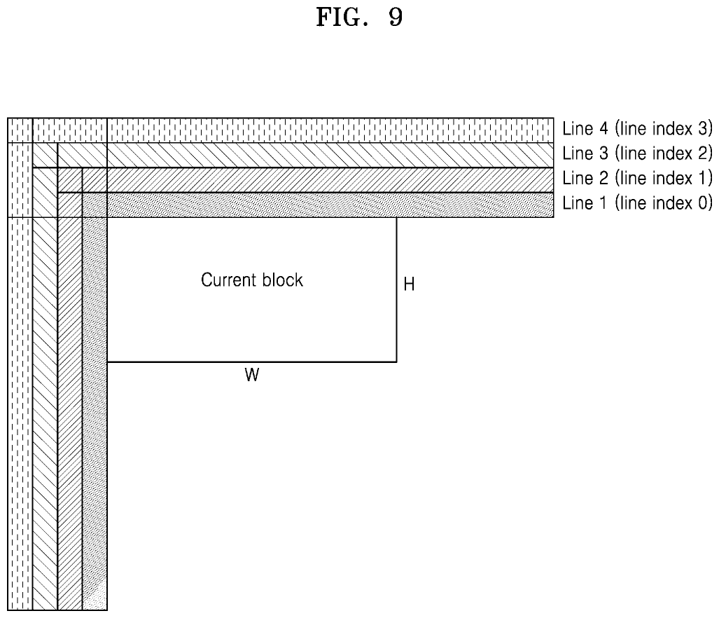

FIG. 9 illustrates an example of multiple reference lines of neighboring reference samples for intra prediction. Although four lines are illustrated herein merely as an example, more or fewer lines may be used.

Referring to FIG. 9, a line of neighboring reference samples for a current block may include W+H or more top reference samples, H+W or more left reference samples, and at least one more top-left reference sample. Here, line 1 (reference sample line 1) indicates a reference sample line adjacent to the current block. Line 2 (reference sample line 2) indicates a reference sample line located at a distance of one sample from a left/top boundary of the current block. Line 3 (reference sample line 3) indicates a reference sample line located at a distance of two samples from the left/top boundary of the current block. Line 4 (reference sample line 4) indicates a reference sample line located at a distance of three samples from the left/top boundary of the current block.

For example, a top-left reference sample area of line 1 may include one top-left reference sample. Atop-left reference sample area of line 2 may include three top-left reference samples. A top-left reference sample area of line 3 may include five top-left reference samples. A top-left reference sample area of line 4 may include seven top-left reference samples.

For example, when a reference sample line number increases, the number of top-left reference samples in a top-left reference sample area may increase, while the number of top reference samples in a top reference sample area may not increase. For example, the number of top-left reference samples in line n+1 may be greater than the number of top-left reference samples in line n, and the number of top reference samples in line n may be equal to the number of top reference samples in line n+1. For example, n may be 1, 2, 3, and the like.

For example, when the reference sample line number increases, the number of top-left reference samples in the top-left reference sample area may increase, while the number of left reference samples in a left reference sample area may not increase. For example, the number of top-left reference samples in line n+1 may be greater than the number of top-left reference samples in line n, and the number of left reference samples in line n may be equal to the number of left reference samples in line n+1. For example, n may be 1, 2, 3, and the like.

For example, when an intra prediction direction, based on the position of a specific sample in the current block, points to the right of a rightmost reference sample in a top reference line, a predicted sample value of the specific sample may be set equal to a value of the rightmost reference sample. For example, when the intra prediction direction, based on the position of the specific sample in the current block, points to the bottom of a bottommost reference sample in a left reference line, the predicted sample value of the specific sample may be set equal to a value of the bottommost reference sample. Through this method, even when multiple reference lines is used, a fixed number (e.g., W+H) of top reference samples and left reference samples may be used regardless of a line.

Even when the plurality of reference lines is used, some of the neighboring reference samples may not yet have been decoded/reconstructed or may not be available. In this case, the coding apparatus may configure neighboring reference samples to be used for intra prediction by padding or substituting unavailable samples with available samples. A reference line index may be denoted as rlidx.

For example, the top reference samples in reference sample line n may be represented as AboveRow[i], where i may have a value of 0 to W+H−1. When the top reference samples are unavailable, if the left reference samples are available, one of the left reference samples may be used as a sample value for the top reference samples. Specifically, for example, the unavailable top reference samples may be padded or substituted to be identical to an uppermost reference sample among the left neighboring reference samples. That is, the unavailable top reference samples may be padded or substituted to be identical to a left reference sample at a coordinate (x−1−rlidx, y). Here, (x, y) may represent the position of the top-left sample of the current block (e.g., a coding block or transform block). When the top reference samples are unavailable and the left reference samples are also unavailable, the top reference samples may be padded or substituted with a default value derived based on a predetermined bit depth. The default value may be set to, for example, (1<<(BitDepth−1))−1. Alternatively, the unavailable top reference samples may be padded or substituted to be identical to the top-left reference sample at a coordinate (x−1, y−1−rlidx).

When the top reference samples are available, reconstructed sample values of the top reference samples are basically used as values of the top reference samples. When the top reference samples are available, a first parameter may be determined. The first parameter may be determined as, for example, x+2W−1. When H>W, the reconstructed sample values are not used for specific top reference samples having an x-coordinate greater than the first parameter, and a value of a top reference sample having an x-coordinate of the first parameter is copied (padded or substituted) for the specific top reference samples. That is, for the specific top reference samples, a value of a top reference sample at a coordinate (first parameter, y−1) may be copied (padded or substituted). Alternatively, when H>W, a value of a 2W-th top reference sample may be copied (padded or substituted) for top reference samples after the 2W-th top reference sample.

The left reference samples may be represented, for example, as LeftCol[i], where i may have a value of 0 to W+H−1. When the left samples are unavailable, if the top reference samples are available, one of the top reference samples may be used as a sample value for the left reference samples. Specifically, for example, the unavailable left reference samples may be padded or substituted to be identical to a leftmost reference sample among the top neighboring reference samples. That is, the unavailable left reference samples may be padded or substituted to be identical to atop reference sample at a coordinate (x, y−1−rlidx). Here, (x, y) may represent the position of the top-left sample of the current block (e.g., a coding block or transform block). When the left reference samples are unavailable and the top reference samples are also unavailable, the left reference samples may be padded or substituted with a default value derived based on a predetermined bit depth. The default value may be set to, for example, (1<<(BitDepth−1))−1. Alternatively, the unavailable left reference samples may be padded or substituted to be identical to the top-left reference sample at a coordinate (x−1−rlidx, y−1).

When the left reference samples are available, reconstructed sample values of the left reference samples are basically used as values of the left reference samples. When the left reference samples are available, a second parameter may be determined. The second parameter may be determined as, for example, x+2H−1. When W>H, the reconstructed sample values are not used for specific left reference samples having a y-coordinate greater than the second parameter, and a value of a left reference sample having a y-coordinate of the second parameter is copied (padded or substituted) for the specific left reference samples. That is, for the specific left reference samples, a value of a left reference sample at a coordinate (x-1, second parameter) may be copied (padded or substituted). Alternatively, when W>H, a value of a 2H-th left reference sample may be copied (padded or substituted) for left reference samples after the 2H-th left reference sample.

The top-left reference samples may be represented as AboveRow[−i] and/or LeftCol[−j] for convenience, where i may include 1 to rlidx, and j may include 1 to rlidx−1. When the top-left reference sample is available, a reconstructed sample value of the reference sample is used. When the top-left reference sample is unavailable, a value of an available left reference sample at a coordinate ((x−1−rlidx, y) or an available top reference sample at a coordinate (x, y−1−rlidx) may be copied (padded or substituted). When the top-left reference samples are unavailable and both the left reference sample and top reference sample are unavailable, the top-left reference samples may be padded or substituted with a default value derived based on a given bit depth. The default value may be set to, for example, (1<<(BitDepth−1))−1.

Reference line selection information (or reference line index information) related to the plurality of reference lines may be signaled. The reference line selection information may be signaled on a coding block basis. That is, the reference line selection information may be signaled on a coding block basis, reference samples for transform blocks within the coding block may be derived using the same reference line number, and intra prediction may be sequentially performed. In this case, intra prediction may be performed on the transform blocks in raster scan order.

For example, the plurality of reference lines may be applied only when the current block is a luma component block. That is, the reference line selection information may be signaled when the coding block is a luma component block.

For example, when a prediction type is IBP and/or RIP, the reference line selection information may not be explicitly signaled. When the reference line selection information is not explicitly signaled, a value of the reference line selection information may indicate 0, which may indicate line number 1.

For example, the reference line selection information may be signaled after intra prediction mode information is signaled.

TABLE 3

```
...
  intra_pred_mode
  if(is_directional_mode)
    reference_line
...
```

Here, intra_pred_mode represents the intra prediction mode information, and reference_line represents the reference line selection information. is_directional_mode is a variable indicating whether an intra prediction mode of the current block is a directional intra prediction mode. is_directional_mode may not be explicitly signaled, and may be derived based on the intra prediction mode information.

For example, when the coding block is located on (adjacent to) a specific boundary, the reference line selection information may not be signaled. In this case, the value of the reference line selection information is implicitly inferred as 0, and a first left/top reference line may be selected.

In another example, the reference line selection information may be signaled, but an indicated reference line may be set differently. For example, when the coding block is located on (adjacent to) the specific boundary, the reference line selection information may be signaled, but an indicated reference line may be set differently. For example, when the coding block is located on the specific boundary, the reference line selection information may differently indicate a left line number and a top line number. For example, when the coding block is located on the specific boundary, the reference line selection information may selectively indicate one of reference lines 1 to 4 for a left line and indicate only reference line 1 for a top line. In this case, load on a memory buffer may be reduced.

The specific boundary may be a frame boundary, a tile boundary, and/or a superblock boundary. The specific boundary may be a top boundary of a frame, a top boundary of a tile, and/or a top boundary of a superblock.

It is necessary to reconfigure the plurality of reference lines, considering a case where a left line number and atop line number are indicated differently as described above. For example, when reference line 4 is selected for the left line and reference line 1 is selected for the top line, empty spaces may occur between neighboring reference samples according to an existing reference line configuration when performing intra prediction in a top-left direction and adjacent directions thereof.

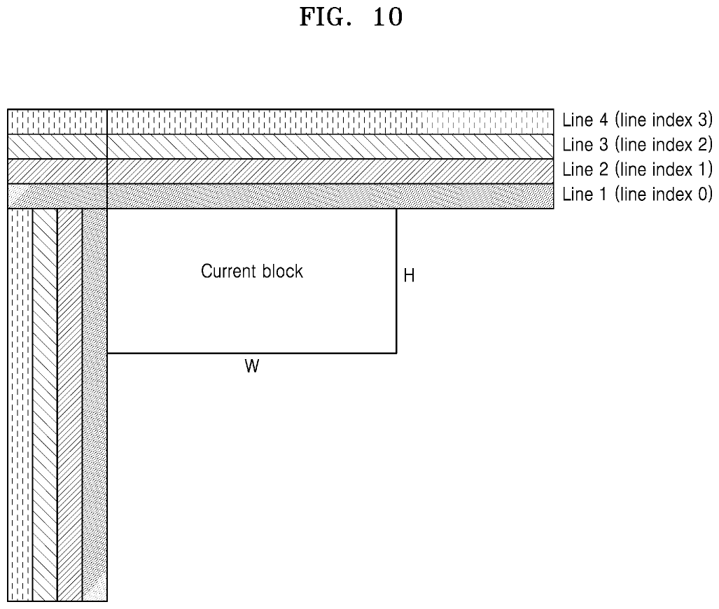

FIG. 10 illustrates an example of multiple lines of neighboring reference samples for intra prediction.

Referring to FIG. 10, a line of neighboring reference samples for a current block may include W+H or more top reference samples, H+W or more left reference samples, and k (e.g., 4) more top-left reference samples. Here, line 1 (reference sample line 1) indicates a reference sample line adjacent to the current block. Line 2 (reference sample line 2) indicates a reference sample line located at a distance of one sample from a left/top boundary of the current block. Line 3 (reference sample line 3) indicates a reference sample line located at a distance of two samples from the left/top boundary of the current block. Line 4 (reference sample line 4) indicates a reference sample line located at a distance of three samples from the left/top boundary of the current block.

The number of top-left reference samples may be the same regardless of a reference sample line number. For example, a top-left reference sample area of line 1 may include four top-left reference samples. A top-left reference sample area of line 2 may include four top-left reference samples. Atop-left reference sample area of line 3 may include four top-left reference samples. Atop-left reference sample area of line 4 may include four top-left reference samples.

For example, when a reference sample line number increases, the number of top-left reference samples in a top-left reference sample area may not increase, and the number of top reference samples in a top reference sample area may not increase either. For example, the number of top-left reference samples in line n may be equal to the number of top-left reference samples in line n+1, and the number of top reference samples in line n may be equal to the number of top reference samples in line n+1. For example, n may be 1, 2, 3, and the like.

For example, when the reference sample line number increases, the number of top-left reference samples in the top-left reference sample area may not increase, and the number of left reference samples in a left reference sample area may not increase either. For example, the number of top-left reference samples in line n may be equal to the number of top-left reference samples in line n+1, and the number of left reference samples in line n may be equal to the number of left reference samples in line n+1. For example, n may be 1, 2, 3, and the like.

Based on the aforementioned structure, even when a left line number and a top line number are determined differently, there is no empty space between neighboring reference samples, thus smoothly performing intra prediction.

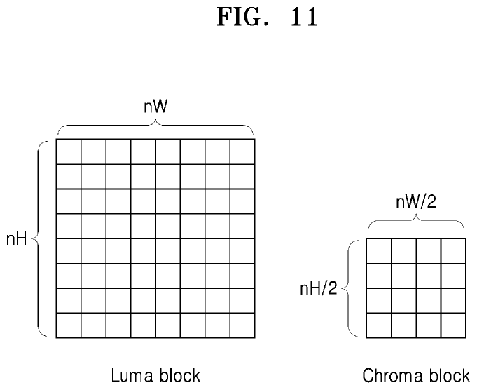

FIG. 11 illustrates an example for explaining a relationship between a luma block and a chroma block.

Referring to FIG. 11, the luma block may refer to a luma component block of a current block, and the current chroma block may refer to a chroma component block of the current block. Accordingly, the luma block and the chroma block may be regarded as corresponding to each other.

For example, in a 4:2:0 color format, a size of a luma block may be twice a size of a chroma block. Accordingly, the luma block may derive a downsampled luma block having the size of the chroma block through downsampling. In this case, the downsampling may be referred to as subsampling, and the downsampled luma block may be a subsampled luma block.

In addition, downsampling may also be performed on neighboring samples of the luma block.

Downsampling may be performed by applying an N-tap filter to the luma block or neighboring samples of the luma block. In this case, the number of taps of a filter applied to the luma block and the number of taps of a filter applied to the neighboring samples of the luma block may be the same or different.

Meanwhile, prediction for a chroma block may be performed using the above-described CFL intra prediction.

For example, prediction for a chroma component may be performed based on a luma component. That is, prediction samples of the chroma block may be derived based on a luma block. In addition, the luma block may correspond to the chroma block. In other words, the luma block and the chroma block may indicate blocks located at the same position.

In addition, as described below, the luma component may include luma samples. For example, the luma component may include luma samples of a corresponding luma block corresponding to the chroma block, and may include neighboring luma samples of the corresponding luma block.

For example, when an intra prediction mode for the chroma block is a CFL intra prediction mode, CFL intra prediction may be performed. Alternatively, the CFL prediction may be performed based on a flag indicating whether the CFL prediction is applied.

Meanwhile, the CFL prediction may be performed based on a size of a current block. For example, when the size of the current block is equal to or smaller than a predetermined size, the CFL prediction may be performed. In this case, the predetermined size may be one of 4, 8, 16, 32, 64, or 128.

In addition, the CFL prediction may be performed based on a width and/or a height of the current block. For example, when a maximum value of the width or the height of the current block is equal to or smaller than a predetermined value, the CFL prediction may be performed. In this case, the predetermined value may be one of 4, 8, 16, 32, or 64.

Meanwhile, for the CFL prediction, CFL related information may be signaled.

For example, when the intra prediction mode for the chroma block is “UV_CFL_PRED”, the CFL related information may be signaled as shown in Table 4 below.

TABLE 4

| | Type |
|---|---|
| intra_frame_mode_info( ) { | |
| skip = 0 | |
| if ( SegIdPreSkip ) | |
| intra_segment_id( ) | |
| skip_mode = 0 | |
| read_skip( ) | |
| if (!SegIdPreSkip ) | |
| intra_segment_id( ) | |
| read_cdef( ) | |
| read_delta_qindex( ) | |
| read_delta_lf( ) | |
| ReadDeltas = 0 | |
| RefFrame[ 0 ] = INTRA_FRAME | |
| RefFrame[ 1 ] = NONE | |
| if ( allow_intrabc ) { | |
| use_intrabc | S( ) |
| } else { | |
| use_intrabc = 0 | |
| } | |
| if ( use_intrabc ) { | |
| is_inter = 1 | |
| YMode = DC_PRED | |
| UVMode = DC_PRED | |
| motion_mode = SIMPLE | |
| compound_type = COMPOUND_AVERAGE | |
| PaletteSizeY = 0 | |
| PaletteSizeUV = 0 | |
| interp_filter[ 0 ] = BILINEAR | |
| interp_filter[ 1 ] = BILINEAR | |
| find_mv_stack( 0 ) | |
| assign_mv( 0 ) | |
| } else { | |
| is_inter = 0 | |
| intra_frame_y_mode | S( ) |
| YMode = intra_frame_y_mode | |
| intra_angle_info_y( ) | |
| if ( HasChroma ) { | |
| uv_mode | S( ) |
| UVMode = uv_mode | |
| if ( UVMode == UV_CFL_PRED ) { | |
| read_cfl_alphas( ) | |
| } | |
| intra_angle_info_uv( ) | |
| } | |
| PaletteSizeY = 0 | |
| PaletteSizeUV = 0 | |
| if ( MiSize >= BLOCK_8X8 && | |
| Block_Width[ MiSize ] <= 64 && | |
| Block_Height[ MiSize ] <= 64 && | |
| allow_screen_content_tools ) { | |
| palette_mode_info( ) | |
| } | |
| filter_intra_mode_info( ) | |
| } | |
| } | |

Alternatively, for example, when the intra prediction mode for the chroma block is “UV_CFL_PRED”, CFL related information may be signaled as shown in Table 5 below.

TABLE 5

| | Type |
|---|---|
| intra_block_mode_info( ) { | |
| RefFrame[ 0 ] = INTRA_FRAME | |
| RefFrame[ 1 ] = NONE | |
| y_mode | |
| YMode = y_mode | |
| intra_angle_info_y( ) | |
| if ( HasChroma ) { | |
| uv_mode | S( ) |
| UVMode = uv_mode | |
| if ( UVMode == UV_CFL_PRED ) { | |
| read_cf1_alphas( ) | |
| } | |
| intra_angle_info_uv( ) | |
| } | |
| PaletteSizeY = 0 | |
| PaletteSizeUV = 0 | |
| if ( MiSize >= BLOCK_8X8 && | |
| Block_Width[ MiSize ] <= 64 && | |
| Block_Height[ MiSize ] <= 64 && | |
| allow_screen_content_tools ) | |
| palette_mode_info( ) | |
| filter_intra_mode_info( ) | |
| } | |

Referring to Table 4 and Table 5, when the intra prediction mode is “UV_CFL_PRED”, “read_cfl_alphas( )” may be derived and CFL related information may be signaled.

In addition, the CFL related information may be represented as shown in Table 6 below.

TABLE 6

| | Type |
|---|---|
| read_cfl_alphas( ) { | |
| cfl_alpha_sign | S( ) |
| signU = (cfl_alpha_signs + 1 ) / 3 | |
| signV = (cfl_alpha_signs + 1 ) % 3 | |
| if ( signU != CFL_SIGN_ZERO ) { | |
| cfl_alpha_u | S( ) |
| CflAlphaU = 1 + cfl_alpha_u | |
| if ( signU == CFL_SIGN_NEG ) | |
| CflAlphaU = −Cf1AlphaU | |
| } else { | |
| CflAlphaU = 0 | |
| } | |
| if ( signV != CFL_SIGN_ZERO ) { | |
| cfl_alpha_v | S( ) |
| CflAlphaV = 1 + cfl_alpha_v | |
| if ( signV == CFL_SIGN_NEG ) | |
| CflAlphaV = −Cf1AlphaV | |
| } else { | |
| CflAlphaV = 0 | |
| } | |

In addition, semantics of the CFL related information may be represented as shown in Table 7 below.

TABLE 7

cfl_alpha_signs contains the sign of the alpha values for U
and V packed together into a single syntax element with 8
possible values. (The combination of two zero signs is
prohibited as it is redundant with DC Intra prediction.)
signU contains the sign of the alpha value for the U
component:
signV contains the sign of the alpha value for the V
component with the same interpretation as for signU.
cfl_alpha_u contains the absolute value of alpha minus
one for the U component.
cfl_alpha_v contains the absolute value of alpha minus
one for the V component.
CflAlphaU contains the signed value of the alpha
component for the U component.
CflAlphaV contains the signed value of the alpha
component for the V component.

Referring to Table 7, “cfl_alpha_signs” may be information regarding signs of alpha values for chroma components, “signU” may be information regarding a sign of an alpha value for a U component, and “signV” may be information regarding a sign of an alpha value for a V component. In addition, “cfl_alpha_u” may be information regarding an absolute value of alpha for the U component, and “cfl_alpha_v” may be information regarding an absolute value of alpha for the V component. Further, “CflAlphaU” may be information including a sign value of an alpha component for the U component, and “CflAlphaV” may be information including a sign value of an alpha component for the V component.

For example, information regarding signs of alpha values for chroma components may be signaled. Specifically, information regarding signs of alpha values for the U component and the V component may be signaled. In this case, the information regarding signs of alpha values for the U component and the V component may be represented as “cfl_alpha_signs”.

For example, information regarding a sign of an alpha value for the U component may be derived based on the information regarding signs of alpha values for chroma components. In addition, information regarding a sign of an alpha value for the V component may be derived based on the information regarding signs of alpha values for chroma components. In this case, the information regarding the sign of the alpha value for the U component may be represented as “signU”, and the information regarding the sign of the alpha value for the V component may be represented as “signV”.

In addition, an alpha value for the U component may be determined according to a value of the information regarding the sign of the alpha value for the U component. For example, when the value of the information regarding the sign of the alpha value for the U component is 0, the information may indicate “CFL_SIGN_ZERO”. In addition, when the value of the information regarding the sign of the alpha value for the U component is 1, the information may indicate “CFL_SIGN_NEG”. In addition, when the value of the information regarding the sign of the alpha value for the U component is 2, the information may indicate “CFL_SIGN_POS”.

For example, when the value of the information regarding the sign of the alpha value for the U component is 0, information regarding an absolute value of alpha for the U component may not be signaled. In this case, the alpha value for the U component may be 0. In addition, when the value of the information regarding the sign of the alpha value for the V component is 0, information regarding an absolute value of alpha for the V component may not be signaled. In this case, the alpha value for the V component may be 0.

In addition, for example, when the value of the information regarding the sign of the alpha value for the U component is 1, the sign of the alpha value for the U component may be changed. In addition, when the value of the information regarding the sign of the alpha value for the V component is 1, the sign of the alpha value for the V component may be changed.

For example, when the value of the information regarding the sign of the alpha value for the U component is 2, the sign of the alpha value for the U component may not be changed. In addition, when the value of the information regarding the sign of the alpha value for the V component is 1, the sign of the alpha value for the V component may not be changed.

For example, information regarding an absolute value of alpha for the U component may be signaled. In addition, information regarding an absolute value of alpha for the V component may be signaled. Specifically, information regarding an absolute value of (alpha−1) for the U component may be signaled, and information regarding an absolute value of (alpha−1) for the V component may be signaled. In this case, the information regarding the absolute value of alpha for the U component may be represented as “cfl_alpha_u”, and the information regarding the absolute value of alpha for the V component may be represented as “cfl_alpha_v”. For example, information regarding an absolute value of alpha for the U component may be derived based on the information regarding the sign of the alpha value for the U component.

In addition, information regarding an absolute value of alpha for the V component may be derived based on the information regarding the sign of the alpha value for the V component.

In addition, for example, when the information regarding the sign of the alpha value for the U component has a specific value, the information regarding the absolute value of alpha for the U component may not be derived. In this case, the alpha value for the U component may be 0. In addition, when the information regarding the sign of the alpha value for the V component has a specific value, the information regarding the absolute value of alpha for the V component may not be derived. In this case, the alpha value for the V component may be 0.

For example, an alpha value for the U component may be derived based on the information regarding the absolute value of alpha for the U component, and an alpha value for the V component may be derived based on the information regarding the absolute value of alpha for the V component. Specifically, the alpha value for the U component may be derived as the information regarding the absolute value of alpha for the U component+1, and the alpha value for the V component may be derived as the information regarding the absolute value of alpha for the V component+1. In this case, the alpha value for the U component may be represented as “CflAlphaU”, and the alpha value for the V component may be represented as “CflAlphaV”.

In addition, for example, the alpha value for the U component may include information regarding a sign of alpha for the U component or information regarding a sign value of an alpha component for the U component. In addition, the alpha value for the V component may include information regarding a sign of alpha for the V component or information regarding a sign value of an alpha component for the V component.

In this case, a sign of the alpha value for the U component may be determined based on the information regarding the sign of the alpha value for the U component. For example, when the information regarding the sign of the alpha value for the U component indicates a negative value, the sign of the alpha value for the U component may be changed. Specifically, when the information regarding the sign of the alpha value for the U component indicates a negative value, the alpha value for the U component may be multiplied by −1 so that a new alpha value may be derived. In this case, the information regarding the sign of the alpha value for the U component may be represented as “CFL_SIGN_NEG”. In addition, when the information regarding the sign of the alpha value for the U component indicates a positive value, the information regarding the sign of the alpha value for the U component may be represented as “CFL_SIGN_POS”.

In addition, for example, a sign of the alpha value for the V component may be determined based on the information regarding the sign of the alpha value for the V component. For example, when the information regarding the sign of the alpha value for the V component indicates a negative value, the sign of the alpha value for the V component may be changed. Specifically, when the information regarding the sign of the alpha value for the V component indicates a negative value, the alpha value for the V component may be multiplied by −1 so that a new alpha value may be derived. In this case, the information regarding the sign of the alpha value for the V component may be represented as “CFL_SIGN_NEG”. In addition, when the information regarding the sign of the alpha value for the V component indicates a positive value, the information regarding the sign of the alpha value for the V component may be represented as “CFL_SIGN_POS”.

In addition, a prediction parameter used for CFL prediction for the U component may be derived based on the information regarding the absolute value of alpha for the U component. In addition, a prediction parameter used for CFL prediction for the V component may be derived based on the information regarding the absolute value of alpha for the V component.

Meanwhile, the U component and the V component of the chroma component described above may be a Cb component and a Cr component of the chroma component, respectively.

In addition, when intra prediction for a chroma block is performed, a CFL (Chroma From Luma) mode may be used as one of intra prediction modes. For example, CFL may be a method of performing prediction for prediction samples of a U component and prediction samples of a V component.

For example, CFL prediction may be performed based on reconstructed luma samples of a luma block and chroma DC prediction. For example, prediction samples of a chroma block may be derived based on the reconstructed luma samples of the luma block and the chroma DC prediction. Here, the chroma DC prediction may be chroma prediction samples on which DC prediction is performed, or the chroma DC prediction may be chroma prediction samples derived based on neighboring chroma samples of the chroma block.

In addition, CFL prediction may be performed based on reconstructed luma samples of a luma block, neighboring luma samples of the luma block, and chroma DC prediction. For example, prediction samples of a chroma block may be derived based on the reconstructed luma samples of the luma block, the neighboring luma samples of the luma block, and the chroma DC prediction.

Here, the chroma DC prediction may be chroma prediction samples on which DC prediction is performed, or the chroma DC prediction may be chroma prediction samples derived based on neighboring chroma samples of the chroma block.

In addition, prediction samples of a chroma block may be derived based on reconstructed luma samples of a luma block, a scaling parameter, and chroma DC prediction.

Subsampling may be performed on the reconstructed luma samples of the luma block. Reconstructed luma samples on which subsampling is performed may be subsampled reconstructed luma samples or reconfigured luma samples. In this case, performing subsampling on the reconstructed luma samples may mean that downsampling is performed on the reconstructed luma samples. Specifically, subsampling may be performed on the reconstructed luma samples using an n-tap filter. In this case, n in the n-tap filter may be a positive integer. For example, the n-tap filter may be a 3-tap, 4-tap, 5-tap, 6-tap, or 7-tap filter. For example, a type of a filter used for the subsampling may be determined based on signaled information. In other words, the filter used for the subsampling may be determined based on the signaled information. In addition, the information may be signaled through a sequence header.

In addition, an average value of a luma component may be derived based on the subsampled reconstructed luma samples. For example, an average value of the subsampled reconstructed luma samples may be configured based on 3 fractional-bit precision. In this case, the average value of the subsampled reconstructed luma samples may be referred to as an average value of reconstructed luma intensity.

In addition, scaled luma samples may be derived based on the subsampled reconstructed luma samples and the average value of the luma component.

For example, the scaled luma samples may be derived using a scaling parameter based on the subsampled reconstructed luma samples and the average value of the luma component. Specifically, the scaled luma samples may be derived by multiplying the scaling parameter by a difference value between the subsampled reconstructed luma samples and the average value of the luma component.

The scaling parameter may be derived based on signaled CFL-related information. Specifically, the scaling parameter may be derived based on signaled scaling parameter-related information. For example, the scaling parameter may be derived based on the CFL-related information described above.

For example, the scaling parameter may be derived based on “CflAlphaU”. In addition, the scaling parameter may be derived based on “CflAlphaV”. Specifically, a scaling parameter used for deriving chroma prediction samples for the U component may be derived based on “CflAlphaU”, and a scaling parameter used for deriving chroma prediction samples for the V component may be derived based on “CflAlphaV”.

In addition, the scaling parameter may be derived based on neighboring reference samples of the luma block or neighboring reference samples of the chroma block. For example, the scaling parameter may be derived based on neighboring reference samples of the luma block, may be derived based on neighboring reference samples of the chroma block, or may be derived based on neighboring reference samples of the luma block and neighboring reference samples of the chroma block.

In this case, neighboring reference samples of the luma block may include top neighboring reference samples of the luma block and left neighboring reference samples of the luma block. Alternatively, the neighboring reference samples of the luma block may include top-right reference samples and bottom-right reference samples of the luma block. Alternatively, the neighboring reference samples of the luma block may include top neighboring reference samples, left neighboring reference samples, top-right neighboring samples, bottom-left neighboring reference samples, and top-left neighboring reference samples of the luma block.

In addition, neighboring reference samples of the chroma block may include top neighboring reference samples of the chroma block and left neighboring reference samples of the chroma block. Alternatively, the neighboring reference samples of the chroma block may include top-right reference samples and bottom-right reference samples of the chroma block. Alternatively, the neighboring reference samples of the chroma block may include top neighboring reference samples, left neighboring reference samples, top-right neighboring samples, bottom-left neighboring reference samples, and top-left neighboring reference samples of the chroma block.

In this case, neighboring reference samples of the luma block may include top neighboring reference samples of the luma block and left neighboring reference samples of the luma block. Alternatively, the neighboring reference samples of the luma block may include top-right reference samples and bottom-right reference samples of the luma block. Alternatively, the neighboring reference samples of the luma block may include top neighboring reference samples, left neighboring reference samples, top-right neighboring samples, bottom-left neighboring reference samples, and a top-left neighboring reference sample of the luma block.

In addition, neighboring reference samples of the chroma block may include top neighboring reference samples of the chroma block and left neighboring reference samples of the chroma block. Alternatively, the neighboring reference samples of the chroma block may include top-right reference samples and bottom-right reference samples of the chroma block. Alternatively, the neighboring reference samples of the chroma block may include top neighboring reference samples, left neighboring reference samples, top-right neighboring samples, bottom-left neighboring reference samples, and a top-left neighboring reference sample of the chroma block.

In this case, neighboring reference samples of the luma block may be neighboring reference samples on which subsampling is performed. For example, subsampling may be performed on the luma block and the neighboring reference samples of the luma block, and the scaling parameter may be derived based on the neighboring reference samples on which the subsampling is performed. That is, the neighboring reference samples of the luma block may include subsampled neighboring reference samples.

In addition, the scaling parameter may be modified. For example, the scaling parameter derived based on signaled information may be derived based on reconstructed chroma samples and reconstructed luma samples. The modified scaling parameter may be derived based on the following equation.

$$a = arg min {sum ( Rec\_c - a * Rec\_y )}^{⋀} 2 \qquad [ Equation 1 ]$$

Here, Rec_c may represent reconstructed chroma samples, Rec_y may represent reconstructed luma samples, a on a right side of the equation may represent a scaling parameter derived based on signaled information, and a on a left side of the equation may represent a modified scaling parameter. The modified scaling parameter may be referred to as an updated scaling parameter.

For example, the scaling parameter a may be modified based on reconstructed chroma samples and reconstructed luma samples. In this case, the reconstructed chroma samples may include neighboring chroma samples of a current chroma block, and the reconstructed luma samples may include neighboring luma samples of the luma block. In addition, the reconstructed chroma samples may include chroma samples included in the current chroma block, and the reconstructed luma samples may include luma samples included in the luma block.

Reconstructed chroma samples used for deriving the modified scaling parameter may include top neighboring samples and left neighboring samples of the chroma block. Alternatively, the reconstructed chroma samples may include only the top neighboring samples of the chroma block or may include only the left neighboring samples of the current block. In addition, the reconstructed chroma samples may include top-right neighboring samples of the chroma block and bottom-left neighboring samples of the current block. Alternatively, the reconstructed chroma samples may include only the top-right neighboring samples of the chroma block or may include only the bottom-left neighboring samples of the chroma block. In addition, the reconstructed chroma samples may include a top-left neighboring sample of the chroma block.

In addition, reconstructed luma samples used for deriving the modified scaling parameter may include top neighboring samples and left neighboring samples of the luma block. Alternatively, the reconstructed luma samples may include only the top neighboring samples of the luma block or may include only the left neighboring samples of the luma block. In addition, the reconstructed luma samples may include top-right neighboring samples of the luma block and bottom-left neighboring samples of the current block. Alternatively, the reconstructed luma samples may include only the top-right neighboring samples of the luma block or may include only the bottom-left neighboring samples of the luma block. In addition, the reconstructed luma samples may include a top-left neighboring sample of the luma block.

In this case, the reconstructed luma samples may be luma samples on which subsampling is performed. For example, subsampling may be performed on the luma block and neighboring samples of the luma block, and the scaling parameter may be derived based on the neighboring samples on which the subsampling is performed. That is, the reconstructed luma samples may include subsampled neighboring samples. In addition, the reconstructed luma samples may include luma samples included in a subsampled luma block.

When the modified scaling parameter is derived, the scaled luma samples may be derived using the modified scaling parameter based on the subsampled reconstructed luma samples and the average value of the luma component.

Meanwhile, it may be determined whether the scaling parameter is derived based on the signaled CFL-related information or derived based on neighboring reference samples of the luma block or neighboring reference samples of the chroma block.

For example, whether the scaling parameter is derived based on the signaled CFL-related information or derived based on neighboring reference samples of the luma block or neighboring reference samples of the chroma block may be determined based on information indicating whether the scaling parameter is derived based on the signaled CFL-related information or derived based on neighboring reference samples of the luma block or neighboring reference samples of the chroma block. In addition, the CFL-related information may be signaled based on the information.

In addition, whether the scaling parameter is derived based on the signaled CFL-related information or derived based on neighboring reference samples of the luma block or neighboring reference samples of the chroma block may be determined based on at least one of a size, a shape, a depth, a partition structure, or color formats of the block. For example, when a size of the current block is less than a threshold value, the CFL-related information may be signaled so that the scaling parameter may be derived.

In addition, it may be determined whether to use the scaling parameter derived based on the signaled CFL-related information or to use the modified scaling parameter. For example, whether to use the scaling parameter derived based on the signaled CFL-related information or to use the modified scaling parameter may be determined based on information indicating whether to use the scaling parameter derived based on the signaled CFL-related information or the modified scaling parameter. That is, information indicating whether to use the modified scaling parameter may be signaled. In this case, the information indicating whether to use the modified scaling parameter may be signaled after the information indicating whether the scaling parameter is derived based on the signaled CFL-related information or derived based on neighboring reference samples of the luma block or neighboring reference samples of the chroma block.

For example, information indicating whether to use the modified scaling parameter may be signaled through a bitstream. When a value of the information is 1, the modified scaling parameter may be derived so that the scaled luma samples may be derived, and when the value of the information is 0, the scaled luma samples may be derived using the signaled scaling parameter described above. Alternatively, when the value of the information is 1, the scaled luma samples may be derived using the signaled scaling parameter, and when the value of the information is 0, the modified scaling parameter may be derived so that the scaled luma samples may be derived.

In addition, whether to use the scaling parameter derived based on the signaled CFL-related information or to use the modified scaling parameter may be determined based on at least one of a size, a shape, a depth, a partition structure, or color formats of the block.

In addition, whether the scaling parameter is derived based on the signaled CFL-related information or derived based on neighboring reference samples of the luma block or neighboring reference samples of the chroma block may be determined based on information indicating whether the scaling parameter is derived based on neighboring reference samples of the luma block or neighboring reference samples of the chroma block or whether the modified scaling parameter is used.

In addition, index information indicating whether the scaling parameter is derived based on the signaled CFL-related information, derived based on neighboring reference samples of the luma block or neighboring reference samples of the chroma block, or whether the modified scaling parameter is used may be signaled.

For example, when the information has a first value, the scaling parameter may be derived based on the signaled CFL-related information. When the information has a second value, the scaling parameter may be derived based on neighboring reference samples of the luma block or neighboring reference samples of the chroma block. When the information has a third value, the modified scaling parameter may be derived based on the scaling parameter.

Prediction samples of the chroma block may be derived based on the scaled luma samples and chroma DC prediction. Here, the chroma DC prediction may be chroma prediction samples obtained by performing DC prediction. Alternatively, the chroma DC prediction may be chroma prediction samples derived based on chroma samples around the chroma block.

In addition, prediction samples of a chroma block may be derived based on reconstructed luma samples of a luma block, luma DC prediction, a scaling parameter, and chroma DC prediction.

Subsampling may be performed on the reconstructed luma samples of the luma block. Reconstructed luma samples on which subsampling is performed may be subsampled reconstructed luma samples or reconfigured luma samples. In this case, performing subsampling on the reconstructed luma samples may mean that downsampling is performed on the reconstructed luma samples.

The luma DC prediction may be luma prediction samples obtained by performing DC prediction. Alternatively, the luma DC prediction may be luma prediction samples derived based on neighboring luma samples.

In addition, scaled luma samples may be derived based on the subsampled reconstructed luma samples and the luma DC prediction.

For example, the scaled luma samples may be derived using a scaling parameter based on the subsampled reconstructed luma samples and the luma DC prediction. Specifically, the scaled luma samples may be derived by multiplying the scaling parameter by a difference value between the subsampled reconstructed luma samples and the luma DC prediction.

The scaling parameter may be derived based on signaled CFL-related information. Specifically, the scaling parameter may be derived based on signaled scaling parameter-related information. For example, the scaling parameter may be derived based on the CFL-related information described above.

For example, the scaling parameter may be derived based on “CflAlphaU”. In addition, the scaling parameter may be derived based on “CflAlphaV”. Specifically, a scaling parameter used for deriving chroma prediction samples for the U component may be derived based on “CflAlphaU”, and a scaling parameter used for deriving chroma prediction samples for the V component may be derived based on “CflAlphaV”.

In addition, the scaling parameter may be modified. For example, the scaling parameter derived based on signaled information may be modified based on reconstructed chroma samples and reconstructed luma samples. In this case, as described above, the scaling parameter may be modified based on Equation 1. That is, the scaling parameter a may be modified based on reconstructed chroma samples and reconstructed luma samples. In this case, the reconstructed chroma samples may include neighboring chroma samples of a current chroma block, and the reconstructed luma samples may include neighboring luma samples of the luma block.

Prediction samples of the chroma block may be derived based on the scaled luma samples and chroma DC prediction. Here, the chroma DC prediction may be chroma prediction samples obtained by performing DC prediction. Alternatively, the chroma DC prediction may be chroma prediction samples derived based on chroma samples around the chroma block. For example, prediction samples of the chroma block may be derived based on the following equation.

Alternatively, the chroma DC prediction may be chroma prediction samples derived based on neighboring chroma samples of the chroma block. For example, prediction samples of the chroma block may be derived based on the following equation.

$$Pred\_c = a ( Rec\_ y - DC\_y ) + DC\_c \qquad [ Equation2 ]$$

Here, Pred_c may represent prediction samples of a chroma block, Rec_y may represent reconstructed luma samples, DC_y may represent luma prediction samples obtained by performing DC prediction, DC_c may represent chroma prediction samples obtained by performing DC prediction, and α may represent a scaling parameter.

For example, α may represent a scaling parameter derived based on signaled information. Alternatively, α may represent the scaling parameter derived based on neighboring reference samples of the luma block or neighboring reference samples of the chroma block described above. Alternatively, α may represent the modified scaling parameter described above.

In addition, for example, DC_y may represent luma prediction samples obtained by performing DC prediction. In this case, the luma prediction samples obtained by performing the DC prediction may be derived based on neighboring luma samples of a reconstructed luma block including the reconstructed luma samples. Alternatively, the luma prediction samples obtained by performing the DC prediction may be derived based on luma samples on which subsampling is performed. That is, subsampling may be performed on the reconstructed luma block and neighboring luma samples of the reconstructed luma block, and the luma prediction samples obtained by performing the DC prediction may be derived based on the neighboring luma samples on which the subsampling is performed.

Meanwhile, neighboring reference samples used in the CFL prediction process may include top reference samples and left reference samples of a current block. For example, neighboring reference samples of the current block may include top-right reference samples and bottom-left reference samples of the current block. In addition, neighboring reference samples of the current block may include top-right reference samples and left reference samples of the current block. In addition, neighboring reference samples of the current block may include top reference samples and bottom-left reference samples of the current block. In addition, neighboring reference samples of the current block may include top reference samples, left reference samples, top-right reference samples, bottom-left reference samples, and a top-left reference sample of the current block. In this case, the current block may be a luma block or a chroma block. As described above, reference samples of the luma block and/or reference samples of the chroma block may be used to derive the scaling parameter in the CFL prediction.

For example, the top reference samples and left reference samples of the luma block and/or the top reference samples and left reference samples of the chroma block may be used to derive the scaling parameter. In addition, the top-right reference samples and bottom-left reference samples of the luma block and/or the top-right reference samples and bottom-left reference samples of the chroma block may be used to derive the scaling parameter. In addition, the top-right reference samples and left reference samples of the luma block and/or the top-right reference samples and left reference samples of the chroma block may be used to derive the scaling parameter. In addition, the top reference samples and bottom-left reference samples of the luma block and/or the top reference samples and bottom-left reference samples of the chroma block may be used to derive the scaling parameter. In addition, the top reference samples, left reference samples, top-right reference samples, bottom-left reference samples, and top-left reference sample of the luma block and/or the top reference samples, left reference samples, top-right reference samples, bottom-left reference samples, and top-left reference sample of the chroma block may be used to derive the scaling parameter.

In addition, information indicating which reference samples among neighboring reference samples of the current block are used to perform the CFL prediction may be signaled. That is, based on the information, it may be determined whether to use the top reference samples and left reference samples of the current block, whether to use the top-right reference samples and bottom-left reference samples of the current block, whether to use the top-right reference samples and left reference samples of the current block, whether to use the top reference samples and bottom-left reference samples of the current block, or whether to use the top reference samples, left reference samples, top-right reference samples, bottom-left reference samples, and top-left reference sample of the current block.

Meanwhile, subsampling may be performed on the reconstructed luma block based on a 4-tap filter, a 5-tap filter, or a 6-tap filter.

For example, when subsampling is performed based on the 4-tap filter, luma samples used for the subsampling may include a luma sample located at a top-left of a corresponding luma sample position of a chroma sample, a luma sample located at a top-right of the corresponding luma sample position, a luma sample located at a bottom-left of the corresponding luma sample position, and a luma sample located at a bottom-right of the corresponding luma sample position.

In addition, when subsampling is performed based on the 5-tap filter, luma samples used for the subsampling may include a luma sample located at a left of a corresponding luma sample position of a chroma sample, a luma sample located at a top of the corresponding luma sample position, a luma sample located at a right of the corresponding luma sample position, a luma sample located at a bottom of the corresponding luma sample position, and a luma sample located at the corresponding luma sample position.

In addition, when subsampling is performed based on the 6-tap filter, luma samples used for the subsampling may include a luma sample located at a top-left of a corresponding luma sample position of a chroma sample, a luma sample located at a top of the corresponding luma sample position, a luma sample located at a top-right of the corresponding luma sample position, a luma sample located at a bottom-left of the corresponding luma sample position, a luma sample located at a bottom of the corresponding luma sample position, and a luma sample located at a bottom-right of the corresponding luma sample position.

Meanwhile, various prediction methods may be used for prediction of a chroma component. For example, in order to reduce the number of bits required for prediction of the chroma component, prediction of the chroma component may be performed using a Cross-Component Linear Model (CCLM), a Gradient Linear Model (GLM), a Filter-based Linear Model (FLM), a Convolution Cross-component Model (CCCM), a Multi-Hypothesis Cross-Component Intra (MH-CCI) prediction method, or the like.

Hereinafter, Mh-CCI prediction will be described.

For example, a chroma intra prediction mode may be determined based on information indicating the chroma intra prediction mode. In this case, Mh-CCI (Multi-Hypothesis Cross-Component Intra) prediction may be performed based on the information indicating the chroma intra prediction mode.

Alternatively, information indicating whether Mh-CCI prediction is available may be signaled. For example, the information may be signaled based on at least one of a size, a shape, a depth, a partition structure, or color formats of a current block.

Mh-CCI prediction is an intra prediction method that uses a correlation between a luma block and a chroma block corresponding to the luma block, and a linear model may be derived based on neighboring samples of the luma block and/or neighboring samples of the chroma block. In this case, prediction samples for the chroma block may be derived based on the luma block and the linear model.

Alternatively, when Mh-CCI prediction is performed, the luma block may be downsampled, and prediction samples for the chroma block may be derived based on the downsampled luma block and the chroma block.

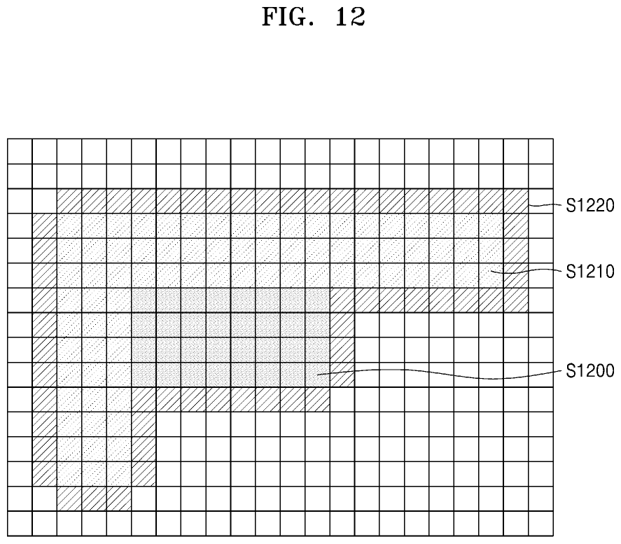

FIG. 12 illustrates an example of a reference sample region used for Mh-CCI prediction.

Referring to FIG. 12, coefficients or parameters used for Mh-CCI prediction may be derived based on a neighboring reference sample region of a current coding block. For example, the neighboring reference sample region may include a plurality of reference sample lines. In FIG. 12, S1200 represents the current coding block, S1210 represents the neighboring reference sample region of the current coding block, and S1220 may represent an unavailable reference sample region.

The reference sample region around the current coding block may include chroma reference samples. For example, prediction for a chroma component may be performed using at least one reference sample line of a chroma block, and the at least one reference sample line may include the chroma reference samples. In this case, a number of the at least one reference sample line may be n. In this case, n may be a positive integer. For example, n may be 1, 2, 3, 4, 5, 6, 7, or 8. In addition, the number of the at least one reference sample line may be determined based on at least one of a size, a shape, a depth, a partition structure, or a color format of the current block.

Further, when the reference sample region around the current coding block is extended and used, an unavailable reference sample region may exist. For example, a region S1220 of FIG. 12 may be an unavailable region. The unavailable region may be padded or substituted based on neighboring reference samples.

In addition, the neighboring reference sample region of the current coding block may be determined based on at least one of a size, a shape, a depth, a partition structure, or a color format of the current coding block.

Meanwhile, when Mh-CCI prediction is performed, information used for Mh-CCI prediction may be signaled. For example, prediction information indicating one of candidate modes including at least one of an Mh-CCI mode, an Mh-CCI_A mode, or an Mh-CCI_L mode may be signaled.

For example, in the case of the Mh-CCI mode, prediction may be performed using both a top reference sample region and a left reference sample region of a current coding block. In the case of the Mh-CCI_A mode, prediction may be performed using only the top reference sample region of the current coding block. In the case of the Mh-CCI_L mode, prediction may be performed using only the left reference sample region of the current coding block. That is, the Mh-CCI mode may use both the top reference sample region and the left reference sample region, the Mh-CCI_A mode may use only the top reference sample region, and the Mh-CCI_L mode may use only the left reference sample region.

In addition, which reference sample region among a top reference sample region or a left reference sample region is to be used may be determined based on at least one of a size, a shape, a depth, a partition structure, or color formats of a current block. For example, when the current block is a non-square block, a longer reference sample region may be used. For example, when a width of the current block is greater than a height, only the left reference sample region may be used, and when the width of the current block is smaller than the height, only the top reference sample region may be used.

In addition, in the case of Mh-CCI prediction, prediction for a chroma block may be performed based on a luma block corresponding to the chroma block. Specifically, prediction for the chroma block may be performed based on reconstructed luma samples of the luma block. For example, prediction for the chroma block may be performed based on reconstructed luma samples of the luma block corresponding to the chroma block. In this case, the reconstructed luma samples of the luma block may include reconstructed luma samples within the luma block and reconstructed samples around the luma block. In addition, the reconstructed samples around the luma block may refer to samples included in a luma reference region around the luma block, and the reconstructed samples around the luma block may be luma reference samples.

Alternatively, the luma block may be a downsampled luma block. For example, the reconstructed luma samples may be downsampled in consideration of a size of the chroma block. For example, reconstructed luma samples within the luma block and reconstructed samples around the luma block may be downsampled. For example, the luma block in the disclosure may be a downsampled luma block. In addition, neighboring luma samples of the luma block may also be downsampled to derive downsampled neighboring luma samples. In this case, an n-tap filter may be used for downsampling, and n in the n-tap filter may be a positive integer. For example, the n-tap filter may be a 3-tap, 4-tap, 5-tap, 6-tap, or 7-tap filter.

In addition, an n-tap filter may be used in Mh-CCI prediction. In this case, n in the n-tap filter may be a positive integer. For example, the n-tap filter may be a 3-tap, 4-tap, 5-tap, 6-tap, or 7-tap filter.

In addition, in Mh-CCI prediction, a chroma prediction sample may be derived based on luma samples. For example, the 5-tap filter may be used when neighboring luma samples located at plus-shaped positions with respect to a luma sample within a luma block are used. Specifically, the neighboring luma samples may include a top neighboring sample of the luma sample, a left neighboring sample of the luma sample, a right neighboring sample of the luma sample, and a bottom neighboring sample of the luma sample. That is, the 5-tap filter may be applied to the luma sample, the top neighboring sample of the luma sample, the left neighboring sample of the luma sample, the right neighboring sample of the luma sample, and the bottom neighboring sample of the luma sample. For example, in the case of the 5-tap filter, a value may be calculated by a convolution between filter coefficients wᵢ and input values. In addition, as described above, the luma sample and the neighboring luma samples may be downsampled luma samples.

In addition, in Mh-CCI prediction, the chroma prediction sample may be derived based on the luma sample, the top neighboring sample of the luma sample, the left neighboring sample of the luma sample, the right neighboring sample of the luma sample, the bottom neighboring sample of the luma sample, a top-left neighboring sample of the luma sample, a top-right neighboring sample of the luma sample, a bottom-left neighboring sample of the luma sample, and a bottom-right neighboring sample of the luma sample. In other words, the chroma prediction sample may be derived based on at least one of the luma sample, the top neighboring sample of the luma sample, the left neighboring sample of the luma sample, the right neighboring sample of the luma sample, the bottom neighboring sample of the luma sample, the top-left neighboring sample of the luma sample, the top-right neighboring sample of the luma sample, the bottom-left neighboring sample of the luma sample, and the bottom-right neighboring sample of the luma sample. In this case, the number of filter taps may be determined according to the number of samples used among the luma sample and the neighboring samples of the luma sample.

In addition, filter coefficients w₁ used in Mh-CCI prediction may be derived based on a chroma block. Specifically, the filter coefficients wi may be derived based on the chroma block and chroma samples within a reference region around the chroma block. For example, the filter coefficients wi may be derived based on MSE (Mean Square Error) between the chroma prediction samples and the reconstructed chroma samples.

Alternatively, the filter coefficients wi may be determined according to a position of a luma sample. For example, filter coefficients wi applied to neighboring luma samples of the luma sample may be set to be greater than filter coefficients wi applied to non-neighboring luma samples of the luma sample. Alternatively, filter coefficients wi applied to neighboring luma samples of the luma sample may be set to be smaller than filter coefficients wi applied to non-neighboring luma samples of the luma sample. Alternatively, the filter coefficients wi may be set to be identical.

Alternatively, the filter coefficients wi may be preset. For example, the filter coefficients wi may be set in advance, and the preset filter coefficients wi may be used.

Alternatively, the filter coefficients wi may be derived based on filter coefficient-related information that is signaled. For example, information indicating values of the filter coefficients wi may be signaled so that values of respective filter coefficients wi may be derived. In addition, a plurality of filter coefficient candidates including the filter coefficients wi may be signaled. For example, information indicating one of the plurality of filter coefficient candidates including the filter coefficients wi may be signaled, and one of the plurality of filter coefficient candidates may be selected based on the information. In this case, the selected filter coefficient candidate may be used for Mh-CCI prediction.

In addition, the reference region around the chroma block may include chroma reference samples. For example, prediction for a chroma component may be performed using at least one reference sample line of the chroma block, and the at least one reference sample line may include the chroma reference samples. In this case, a number of the at least one reference sample line may be n. In this case, n may be a positive integer. For example, n may be 1, 2, 3, 4, 5, 6, 7, or 8. In addition, the number of the at least one reference sample line may be determined based on at least one of a size, a shape, a depth, a partition structure, or a color format of the current block.

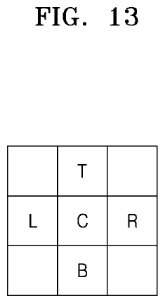

FIG. 13 illustrates an example of positions of luma samples used in Mh-CCI prediction. Referring to FIG. 13, C may represent a luma sample, T may represent a top neighboring sample of the luma sample, L may represent a left neighboring sample of the luma sample, R may represent a right neighboring sample of the luma sample, and B may represent a bottom neighboring sample of the luma sample. In addition, C may represent a value of the luma sample, T may represent a value of the top neighboring sample of the luma sample, L may represent a value of the left neighboring sample of the luma sample, R may represent a value of the right neighboring sample of the luma sample, and B may represent a value of the bottom neighboring sample of the luma sample. In this case, a chroma prediction sample may be derived based on C, T, L, R, and B. In addition, as described above, the luma samples C, T, L, R, and B may be downsampled luma samples.

The chroma prediction sample may be derived based on the following equation.

$$predChromaVal = {w}_{0} * a + {w}_{1} * b + {w}_{2} * c + {w}_{3} * d + {w}_{4} * e \qquad [ Equation 3 ]$$

Here, w0, w1, w2, w3, and w4 are filter coefficients derived based on chroma samples within a chroma block and a reference region around the chroma block, and predChromaVal may represent a chroma prediction sample or a variable for deriving the chroma prediction sample.

In addition, a, b, c, d, and e may be values derived based on a luma sample, a top neighboring sample of the luma sample, a left neighboring sample of the luma sample, a right neighboring sample of the luma sample, and a bottom neighboring sample of the luma sample. That is, a, b, c, d, and e may be determined based on C, T, L, R, and B.

For example, a may be C, b may be T, c may be L, d may be R, and e may be B. This may be expressed by the following equation.

$$predChromaVal = {W}_{0} * ( C ) + {W}_{1} * ( T ) + {W}_{2} * ( L ) + {W}_{3} * ( R ) + {W}_{4} * ( B ) \qquad [ Equation 4 ]$$

In addition, for example, a may be (L−R), b may be (T−B), c may be (L+R), d may be (T+B), and e may be Median(C, L, T, R, B). That is, a and c may be determined based on a left neighboring sample and a right neighboring sample of a luma sample, b and d may be determined based on a top neighboring sample and a bottom neighboring sample of the luma sample, and e may be determined based on a median value of the luma sample, the top neighboring sample, the left neighboring sample, the right neighboring sample, and the bottom neighboring sample of the luma sample. In addition, a may be determined as (R−L), and b may be determined as (B−T). This may be represented by the following equation.

$$predChromaVal = {w}_{0} * ( L - R ) + {w}_{1} * ( T - B ) + {w}_{2} * ( L + R ) + {w}_{3} * ( T + B ) + {w}_{4} * ( Median ( C , L , T , R , B ) ) \qquad [ Equation 5 ]$$

In addition, for example, a may be (T−L), b may be (R−B), c may be (T+L), d may be (R+B), and e may be Median(C, L, T, R, B). That is, a and c may be determined based on a top neighboring sample and a left neighboring sample of a luma sample, b and d may be determined based on a right neighboring sample and a bottom neighboring sample of the luma sample, and e may be determined based on a median value of the luma sample, the top neighboring sample, the left neighboring sample, the right neighboring sample, and the bottom neighboring sample of the luma sample. In addition, a may be determined as (L−T), and b may be determined as (B−R). This may be represented by the following equation.

$$predChromaVal = {w}_{0} * ( T - L ) + {w}_{1} * ( R - B ) + {w}_{2} * ( T + L ) + {w}_{3} * ( R + B ) + {w}_{4} * ( Median ( C , L , T , R , B ) ) \qquad [ Equation 6 ]$$

In addition, for example, a may be (T−R), b may be (L−B), c may be (T+R), d may be (L+B), and e may be Median(C, L, T, R, B). That is, a and c may be determined based on a top neighboring sample and a right neighboring sample of a luma sample, b and d may be determined based on a left neighboring sample and a bottom neighboring sample of the luma sample, and e may be determined based on a median value of the luma sample, the top neighboring sample, the left neighboring sample, the right neighboring sample, and the bottom neighboring sample of the luma sample. In addition, a may be determined as (R−T), and b may be determined as (B−L). This may be represented by the following equation.

$$predChromaVal = {w}_{0} * ( T - L ) + {w}_{1} * ( R - B ) + {w}_{2} * ( T + R ) + {w}_{3} * ( L + B ) + {w}_{4} * ( Median ( C , L , T , R , B ) ) \qquad [ Equation 7 ]$$

In addition, the chroma prediction sample may be derived based on the following equation.

$$predChromaVal = {w}_{0} * a + {w}_{1} * b + {w}_{2} * c + {w}_{3} * d + {w}_{4} * e + {w}_{5} * f \qquad [ Equation 8 ]$$

Here, w0, w1, w2, w3, w4, and w5 are filter coefficients derived based on chroma samples in a reference region around a chroma block and the chroma block, and predChromaVal may indicate a chroma prediction sample or a variable for deriving the chroma prediction sample.

For example, a, b, c, d, and e may be values derived based on the luma sample, a top neighboring sample of the luma sample, a left neighboring sample of the luma sample, a right neighboring sample of the luma sample, and a bottom neighboring sample of the luma sample, as described above. In this case, f may be C. That is, f may indicate a value of the luma sample. In addition, f may indicate a scalar offset between an input and an output, and may be set as an intermediate chroma sample value.

Meanwhile, a, b, c, d, e, and f in Equation 8 may be values derived based on the luma sample, the top neighboring sample of the luma sample, the left neighboring sample of the luma sample, the right neighboring sample of the luma sample, and the bottom neighboring sample of the luma sample.

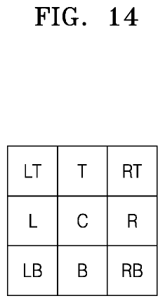

FIG. 14 illustrates another example of positions of luma samples used in Mh-CCI prediction.

Referring to FIG. 14, C may indicate a luma sample, T may indicate a top neighboring sample of the luma sample, L may indicate a left neighboring sample of the luma sample, R may indicate a right neighboring sample of the luma sample, and B may indicate a bottom neighboring sample of the luma sample. LT may indicate a top-left neighboring sample of the luma sample, RT may indicate a top-right neighboring sample of the luma sample, LB may indicate a bottom-left neighboring sample of the luma sample, and RB may indicate a bottom-right neighboring sample of the luma sample. In addition, C may indicate a value of the luma sample, T may indicate a value of the top neighboring sample of the luma sample, L may indicate a value of the left neighboring sample of the luma sample, R may indicate a value of the right neighboring sample of the luma sample, and B may indicate a value of the bottom neighboring sample of the luma sample. LT may indicate a value of the top-left neighboring sample of the luma sample, RT may indicate a value of the top-right neighboring sample of the luma sample, LB may indicate a value of the bottom-left neighboring sample of the luma sample, and RB may indicate a value of the bottom-right neighboring sample of the luma sample. In this case, a chroma prediction sample may be derived based on at least one of C, T, L, R, B, LT, RT, LB, and RB. Here, the luma samples may be samples of a downsampled luma block. In this case, the chroma prediction sample may be derived based on the following equations.

$$predChromaVal = {w}_{0} * ( C ) + {w}_{1} * ( L - R ) + {w}_{2} * ( T - B ) + {w}_{3} * ( L + R ) + {w}_{4} * ( T + B ) + {w}_{5} * ( Median ( C , L , T , R . B ) ) \qquad [ Equation 9 ]$$

$$predChromaVal = {w}_{0} * ( C ) + {w}_{1} * ( LT ) + {w}_{2} * ( RT ) + {w}_{3} * ( LB ) + {w}_{4} * ( RB ) + {w}_{5} * ( Median ( C , LT , RT , LB , RB ) ) \qquad [ Equation 10 ]$$

$$predChromaVal = {w}_{0} * ( LT - RB ) + {w}_{1} * ( LB - RT ) + {w}_{2} * ( LT + RB ) + {w}_{3} * ( LB + RT ) + {w}_{4} * ( Median ( C , LT , RT , LB , RB ) ) \qquad [ Equation 11 ]$$

$$predChromaVal = {w}_{0} * ( LT - RT ) + {w}_{1} * ( LB - RB ) + {w}_{2} * ( LT + RT ) + {w}_{3} * ( LB + RB ) + {w}_{4} * ( Median ( C , LT , RT , LB , RB ) ) \qquad [ Equation 12 ]$$

$$predChromaVal = {w}_{0} * ( LT - LB ) + {w}_{1} * ( RT - RB ) + {w}_{2} * ( LT + LB ) + {w}_{3} * ( RT + RB ) + {w}_{4} * ( Median ( C , LT , RT , LB , RB ) ) \qquad [ Equation 13 ]$$

In the case of Equations 10 to 13, a chroma prediction sample may be derived based on a top-left neighboring sample, a top-right neighboring sample, a bottom-left neighboring sample, and a bottom-right neighboring sample of the luma sample.

Meanwhile, in the above-described Equation 4, a, b, c, d, and e may be modified based on an offset value, and a value of the chroma prediction sample may also be modified based on the offset value. This may be represented by the following equation.

$$predChromaVal = {w}_{0} * ( a - offsetLuma ) + {w}_{1} * ( b - offsetLuma ) + {w}_{2} * ( c - offsetLuma ) + {w}_{3} * ( d - offsetLuma ) + {w}_{4} * ( e - offsetLuma ) + offsetChroma \qquad [ Equation 14 ]$$

Here, the offsetLuma value may be a preset variable or a value of a reference sample located outside a top-left corner of a current block. In addition, the offsetChroma value may be a preset variable or a value of a reference sample located outside the top-left corner of the current block. In this case, the offsetChroma value may vary depending on a type of a chroma component.

For example, in Equation 14, a sample value may be modified based on the offsetLuma value or the offsetChroma value, thereby improving prediction efficiency and reducing complexity.

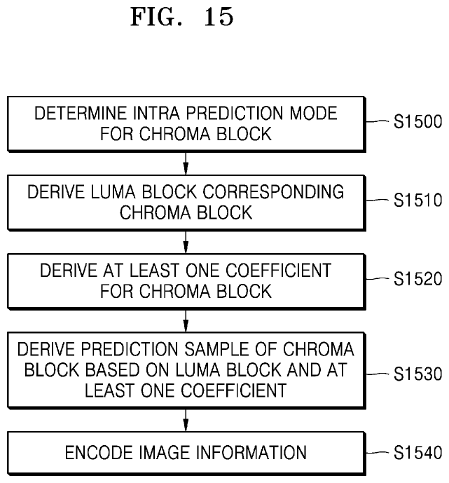

FIG. 15 schematically illustrates a video/image encoding method according to embodiment(s) of the present disclosure. The method disclosed in FIG. 15 may be performed by the encoding apparatus disclosed in FIG. 2. Specifically, for example, S1500 to S1530 of FIG. 15 may be performed by the predictor 220 of the encoding apparatus 200, and S1540 may be performed by the entropy encoder 240 of the encoding apparatus 200. The method disclosed in FIG. 15 may include the above-described embodiments of the present disclosure.

Referring to FIG. 15, an encoding apparatus determines an intra prediction mode for a chroma block (S1500). For example, the encoding apparatus may determine the intra prediction mode for the chroma block.

For example, it may be determined whether Mh-CCI prediction is performed for the chroma block.

The encoding apparatus derives a luma block corresponding to the chroma block (S1510). For example, the encoding apparatus may derive the luma block corresponding to the chroma block.

The chroma block may include a chroma sample, and the luma block may include a luma sample corresponding to the chroma sample. In other words, luma samples corresponding to chroma samples included in the chroma block may be included in the luma block.

In this case, the luma block may include at least one of a left sample, atop sample, a right sample, a bottom sample, a top-left sample, a top-right sample, a bottom-left sample, or a bottom-right sample of the luma sample.

In addition, luma samples corresponding to neighboring reference samples of the chroma block may be derived. For example, neighboring reference samples of the luma block may correspond to neighboring reference samples of the chroma block.

Alternatively, the encoding apparatus may downsample the luma block. The decoding apparatus may downsample the luma block considering a size of the chroma block. In this case, the downsampled luma block may include a luma sample corresponding to the chroma sample.

In this case, the downsampled luma block may include at least one of a left sample, a top sample, a right sample, a bottom sample, a top-left sample, a top-right sample, a bottom-left sample, or a bottom-right sample of the luma sample.

The encoding apparatus derives at least one coefficient for the chroma block (S1520). For example, the encoding apparatus may derive the at least one coefficient for the chroma block. In addition, the encoding apparatus may derive at least one neighboring reference sample line of the chroma block.

For example, the at least one coefficient may be derived based on the at least one neighboring reference sample line. In other words, the at least one coefficient may be derived based on reference samples included in the at least one neighboring reference sample line of the chroma block.

The number of the at least one reference sample line may be determined based on at least one of a size of the chroma block, a shape of the chroma block, an intra prediction mode, a split type, a split depth, and a color format.

For example, the intra prediction mode may be one of a first mode, a second mode, or a third mode. In this case, when the intra prediction mode is the first mode, the at least one coefficient may be derived based on a top neighboring reference sample region, a left neighboring reference sample region, and a top-left neighboring reference sample region of the chroma block. In addition, when the intra prediction mode is the second mode, the at least one coefficient may be derived based on the top neighboring reference sample region of the chroma block. In addition, when the intra prediction mode is the third mode, the at least one coefficient may be derived based on the left neighboring reference sample region of the chroma block.

In addition, the image information may include information indicating that the intra prediction mode is one of the first mode, the second mode, or the third mode.

In addition, the at least one coefficient may be derived based on signaled filter coefficient related information. For example, each filter coefficient may be derived by signaling information indicating a value of the at least one coefficient.

The encoding apparatus derives a prediction sample of the chroma block based on the luma block and the at least one coefficient (S1530). For example, the encoding apparatus may derive the prediction sample of the chroma block based on the luma block and the at least one coefficient.

The luma block may include at least one of a left sample, a top sample, a right sample, a bottom sample, a top-left sample, a top-right sample, a bottom-left sample, or a bottom-right sample of a luma sample. As described above, the luma block may be a luma block corresponding to the chroma block or a downsampled luma block obtained by downsampling the luma block corresponding to the chroma block.

The prediction sample of the chroma block may be derived by applying an n-tap filter to at least one of the left sample, the top sample, the right sample, the bottom sample, the top-left sample, the top-right sample, the bottom-left sample, or the bottom-right sample of the luma sample.

For example, a first sample value may be derived based on the left sample and the right sample of the luma sample, a second sample value may be derived based on the top sample and the bottom sample of the luma sample, a third sample value may be derived based on the left sample and the right sample of the luma sample, a fourth sample value may be derived based on the top sample and the bottom sample of the luma sample, and a fifth sample value may be derived based on the luma sample, the left sample of the luma sample, the top sample of the luma sample, the right sample of the luma sample, and the bottom sample of the luma sample. In this case, the prediction sample of the chroma block may be derived based on the first sample value, the second sample value, the third sample value, the fourth sample value, and the fifth sample value.

For example, the first sample value may be derived based on a difference between a value of the left sample of the luma sample and a value of the right sample of the luma sample, the second sample value may be derived based on a difference between a value of the top sample of the luma sample and a value of the bottom sample of the luma sample, the third sample value may be derived based on a sum of the value of the left sample of the luma sample and the value of the right sample of the luma sample, the fourth sample value may be derived based on a sum of the value of the top sample of the luma sample and the value of the bottom sample of the luma sample, and the fifth sample value may be derived based on a median value of the value of the luma sample, the value of the left sample of the luma sample, the value of the top sample of the luma sample, the value of the right sample of the luma sample, and the value of the bottom sample of the luma sample. In this case, the prediction sample of the chroma block may be derived based on the first sample value, the second sample value, the third sample value, the fourth sample value, and the fifth sample value.

For example, the prediction sample of the chroma block may be derived based on the following equation.

$$predChroma = {w}_{0} * a + {w}_{1} * b + {w}_{2} * c + {w}_{3} * d + {w}_{4} * e \qquad [ Equation 15 ]$$

Here, a may indicate the first sample value, b may indicate the second sample value, c may indicate the third sample value, d may indicate the fourth sample value, and e may indicate the fifth sample value. In addition, w0, w1, w2, w3, and w4 may indicate the at least one coefficient.

In addition, for example, a modified first sample value may be derived based on the first sample value and a luma offset value, a modified second sample value may be derived based on the second sample value and the luma offset value, a modified third sample value may be derived based on the third sample value and the luma offset value, a modified fourth sample value may be derived based on the fourth sample value and the luma offset value, and a modified fifth sample value may be derived based on the fifth sample value and the luma offset value. In this case, the prediction sample of the chroma block may be derived based on the modified first sample value, the modified second sample value, the modified third sample value, the modified fourth sample value, the modified fifth sample value, and a chroma offset value.

The above description may be equally applied when the luma block is a downsampled luma block.

The encoding apparatus encodes image information (S1540). For example, the encoding apparatus may encode the image information. The image information may include the intra prediction related information. The image information may further include prediction related information, transform information, and residual information, as described above. In addition, the image information may include information indicating whether a prediction sample of the chroma block is derived based on the luma block. In addition, the intra prediction related information may include Mh-CCI related information. In addition, the image information may include filter coefficient related information. The image information may also include information described in the present disclosure.

Meanwhile, the image information may include residual information. The residual information is information related to residual samples. The residual information may include information related to quantized transform coefficients for the residual samples.

The encoded image information may be output in a form of a bitstream. The bitstream may be transmitted to a decoding apparatus through a network or a storage medium. For example, image data including the bitstream may be transmitted to the decoding apparatus by a transmission apparatus (or a transmitter). In this case, the image data including the bitstream may be transmitted to the decoding apparatus through a streaming server.

In addition, as described above, the encoding apparatus may generate a reconstructed frame (including reconstructed samples and a reconstructed block) based on the prediction samples and the residual samples. This is to derive, in the encoding apparatus, the same prediction result as that performed in the decoding apparatus, thereby improving coding efficiency. Accordingly, the encoding apparatus may store the reconstructed frame (or reconstructed samples or a reconstructed block) in a memory and use it as a reference frame for inter prediction. As described above, an in-loop filtering procedure and the like may be further applied to the reconstructed frame.

According to the above-described embodiment(s), a prediction sample of a chroma block may be derived based on coefficients derived based on luma samples of a luma block and neighboring reference samples, thereby enabling efficient intra prediction by considering characteristics between color components. In addition, more accurate intra prediction may be performed by using relationships among neighboring samples adjacent to the luma sample.

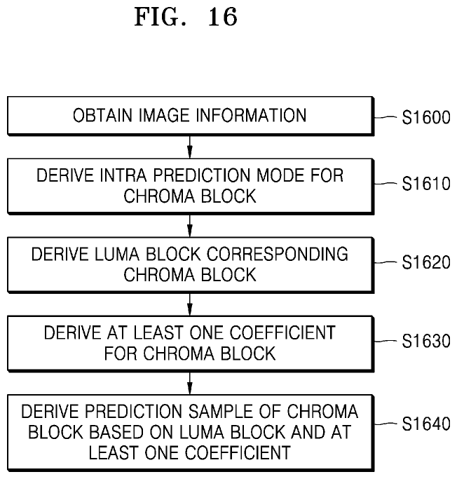

FIG. 16 schematically illustrates a video/image decoding method according to embodiment(s) of the present disclosure. The method disclosed in FIG. 16 may be performed by the decoding apparatus disclosed in FIG. 3. Specifically, for example, S1600 of FIG. 16 may be performed by an entropy decoder 310 of the decoding apparatus 300, and S1610 to S1640 may be performed by a predictor 330 of the decoding apparatus 300. The method disclosed in FIG. 16 may include the above-described embodiments of the present disclosure.

Referring to FIG. 16, the decoding apparatus obtains image information including intra prediction related information (S1600). For example, the decoding apparatus may obtain the image information including the intra prediction related information through a bitstream. The image information may further include prediction related information, transform information, and residual information, as described above. In addition, the image information may include information indicating whether a prediction sample of a chroma block is derived based on a luma block. In addition, the intra prediction related information may include Mh-CCI related information. In addition, the image information may include filter coefficient related information. The image information may also include information described in the present disclosure.

The decoding apparatus derives an intra prediction mode for the chroma block (S1610). For example, the decoding apparatus may derive the intra prediction mode for the chroma block.

For example, whether Mh-CCI prediction is performed for the chroma block may be determined based on the Mh-CCI related information. Specifically, information related to whether Mh-CCI prediction is performed for the chroma block may be signaled, and Mh-CCI prediction may be performed for the chroma block based on the information.

The decoding apparatus derives a luma block corresponding to the chroma block (S1620). For example, the decoding apparatus may derive the luma block corresponding to the chroma block.

The chroma block may include a chroma sample, and the luma block may include a luma sample corresponding to the chroma sample. In other words, luma samples corresponding to chroma samples included in the chroma block may be included in the luma block.

In this case, the luma block may include at least one of a left sample, atop sample, a right sample, a bottom sample, a top-left sample, a top-right sample, a bottom-left sample, or a bottom-right sample of the luma sample.

In addition, luma samples corresponding to neighboring reference samples of the chroma block may be derived. For example, neighboring reference samples of the luma block may correspond to neighboring reference samples of the chroma block.

Alternatively, the decoding apparatus may downsample the luma block. The decoding apparatus may downsample the luma block considering a size of the chroma block. In this case, the downsampled luma block may include a luma sample corresponding to the chroma sample.

In this case, the downsampled luma block may include at least one of a left sample, a top sample, a right sample, a bottom sample, a top-left sample, a top-right sample, a bottom-left sample, or a bottom-right sample of the luma sample.

The decoding apparatus derives at least one coefficient for the chroma block (S1630). For example, the decoding apparatus may derive the at least one coefficient for the chroma block. In addition, the decoding apparatus may derive at least one neighboring reference sample line of the chroma block.

For example, the at least one coefficient may be derived based on the at least one neighboring reference sample line. In other words, the at least one coefficient may be derived based on reference samples included in the at least one neighboring reference sample line of the chroma block.

The number of the at least one reference sample line may be determined based on at least one of a size of the chroma block, a shape of the chroma block, an intra prediction mode, a split type, a split depth, and a color format.

For example, the intra prediction mode may be one of a first mode, a second mode, or a third mode. In this case, when the intra prediction mode is the first mode, the at least one coefficient may be derived based on a top neighboring reference sample region, a left neighboring reference sample region, and a top-left neighboring reference sample region of the chroma block. In addition, when the intra prediction mode is the second mode, the at least one coefficient may be derived based on the top neighboring reference sample region of the chroma block. In addition, when the intra prediction mode is the third mode, the at least one coefficient may be derived based on the left neighboring reference sample region of the chroma block.

In addition, the image information may include information indicating that the intra prediction mode is one of the first mode, the second mode, or the third mode.

In addition, the at least one coefficient may be derived based on signaled filter coefficient related information. For example, each filter coefficient may be derived by signaling information indicating a value of the at least one coefficient.

The decoding apparatus derives a prediction sample of the chroma block based on the luma block and the at least one coefficient (S1640). For example, the decoding apparatus may derive the prediction sample of the chroma block based on the luma block and the at least one coefficient.

The luma block may include at least one of a left sample, a top sample, a right sample, a bottom sample, a top-left sample, a top-right sample, a bottom-left sample, or a bottom-right sample of a luma sample. As described above, the luma block may be a luma block corresponding to the chroma block or a downsampled luma block obtained by downsampling the luma block corresponding to the chroma block.

The prediction sample of the chroma block may be derived by applying an n-tap filter to at least one of the left sample, the top sample, the right sample, the bottom sample, the top-left sample, the top-right sample, the bottom-left sample, or the bottom-right sample of the luma sample.

For example, a first sample value may be derived based on the left sample and the right sample of the luma sample, a second sample value may be derived based on the top sample and the bottom sample of the luma sample, a third sample value may be derived based on the left sample and the right sample of the luma sample, a fourth sample value may be derived based on the top sample and the bottom sample of the luma sample, and a fifth sample value may be derived based on the luma sample, the left sample of the luma sample, the top sample of the luma sample, the right sample of the luma sample, and the bottom sample of the luma sample. In this case, the prediction sample of the chroma block may be derived based on the first sample value, the second sample value, the third sample value, the fourth sample value, and the fifth sample value.

For example, the first sample value may be derived based on a difference between a value of the left sample of the luma sample and a value of the right sample of the luma sample, the second sample value may be derived based on a difference between a value of the top sample of the luma sample and a value of the bottom sample of the luma sample, the third sample value may be derived based on a sum of the value of the left sample of the luma sample and the value of the right sample of the luma sample, the fourth sample value may be derived based on a sum of the value of the top sample of the luma sample and the value of the bottom sample of the luma sample, and the fifth sample value may be derived based on a median value of the value of the luma sample, the value of the left sample of the luma sample, the value of the top sample of the luma sample, the value of the right sample of the luma sample, and the value of the bottom sample of the luma sample. In this case, the prediction sample of the chroma block may be derived based on the first sample value, the second sample value, the third sample value, the fourth sample value, and the fifth sample value.

For example, the prediction sample of the chroma block may be derived based on the following equation.

$$predChroma = {w}_{0} * a + {w}_{1} * b + {w}_{2} * c + {w}_{3} * d + {w}_{4} * e \qquad [ Equation 16 ]$$

Here, a may indicate the first sample value, b may indicate the second sample value, c may indicate the third sample value, d may indicate the fourth sample value, and e may indicate the fifth sample value. In addition, w0, w1, w2, w3, and w4 may indicate the at least one coefficient.

In addition, for example, a modified first sample value may be derived based on the first sample value and a luma offset value, a modified second sample value may be derived based on the second sample value and the luma offset value, a modified third sample value may be derived based on the third sample value and the luma offset value, a modified fourth sample value may be derived based on the fourth sample value and the luma offset value, and a modified fifth sample value may be derived based on the fifth sample value and the luma offset value. In this case, the prediction sample of the chroma block may be derived based on the modified first sample value, the modified second sample value, the modified third sample value, the modified fourth sample value, the modified fifth sample value, and a chroma offset value.

The above description may be equally applied when the luma block is a downsampled luma block.

According to the above-described embodiment(s), a prediction sample of the chroma block may be derived based on coefficients derived based on luma samples of the luma block and neighboring reference samples, thereby enabling efficient intra prediction by considering characteristics between color components. In addition, more accurate intra prediction may be performed by using relationships among neighboring samples adjacent to the luma sample.

Although the methods are described based on a flowchart as a series of steps or blocks in the aforementioned embodiments, the embodiments are not limited to the order of the steps, and a certain step may occur in a different order or concurrently with another step described above. Furthermore, it will be understood by those skilled in the art that the steps shown in the flowchart are not exclusive, and that other steps may be included or one or more steps in the flowchart may be deleted without affecting the scope of the embodiments of the disclosure.

The aforementioned methods according to the embodiments of the disclosure may be implemented in software form, and the encoding apparatus and/or the decoding apparatus according to the disclosure may be included in a device for performing image processing, for example, a TV, a computer, a smartphone, a set-top box, and a display device.

The aforementioned embodiments of the disclosure may be implemented in the form of a recording medium including a computer-executable (program) instruction, such as a program module executed by a computer. The module may be stored in a memory and executed by a processor. The memory may reside inside or outside the processor, and may be connected to the processor by various well-known means. A computer-readable medium may be any available medium accessible by a computer, and may include both volatile and nonvolatile media and removable and non-removable media. Furthermore, the computer-readable medium may include both a computer storage medium and a communication medium. The computer storage medium may include both volatile and nonvolatile media and removable and non-removable media implemented in any method or technology for storing information, such as a computer-readable instruction, a data structure, a program module, or other data. The communication medium typically includes a computer-readable instruction, a data structure, a program module, other data in a modulated data signal such as a carrier wave, or other transfer mechanisms, and includes any information delivery medium.

Furthermore, the embodiments of the disclosure described above may be implemented as a computer program (or computer program product) including a computer-executable instruction. The computer program may include a programmable machine instruction processed by a processor, and may be implemented in a high-level programming language, an object-oriented programming language, an assembly language, or a machine language. In addition, the computer program may be recorded in a tangible computer-readable recording medium (e.g., a memory, a hard disk, a magnetic/optical medium, or a solid-state drive (SSD).

Therefore, the embodiments of the disclosure may be implemented as the aforementioned computer program is executed by a computing device. The computing device may include at least some of a processor, a memory, a storage device, a high-speed interface connected to the memory and a high-speed expansion port, and a low-speed interface connected to a low-speed bus and the storage device. These components may be interconnected via various buses, and may be mounted on a common motherboard or in other suitable manners.

The processor may process an instruction within the computing device. The instruction may include an instruction stored in the memory or the storage device to display graphical information for providing a graphical user interface (GUI) on an external input/output device, such as a display connected to the high-speed interface. In another embodiment, a plurality of processors and/or a plurality of buses may be utilized appropriately along with a plurality of memories and memory types. Further, the processor may be implemented as a chipset of chips including a plurality of independent analog and (or) digital processors.

The memory stores information within the computing device. For example, the memory may include a volatile memory unit or a set of volatile memory units. In another example, the memory may include a nonvolatile memory unit or a set of nonvolatile memory units. The memory may also be another form of computer-readable medium, such as a magnetic or optical disk.

The storage device may provide a high-capacity storage space for the computing device. The storage device may be a computer-readable medium or a component including a computer-readable medium. For example, the storage device may include devices or other components within a storage area network (SAN), and may be a floppy disk device, a hard disk device, an optical disk device, a tape device, a flash memory, other similar semiconductor memory devices, or an array of devices.

The network may be implemented as a wired network, such as a local area network (LAN), a wide area network (WAN), or a value-added network (VAN), or various types of wireless networks, such as a mobile radio communication network or a satellite communication network.

Although the disclosure has been described with reference to the embodiments illustrated in the drawings, these embodiments are merely exemplary. It will be understood by those skilled in the art that various modifications and variations of the embodiments are possible. That is, the scope of the disclosure is not limited to the above-described embodiments, and various modifications and alterations made by those skilled in the art based on the basic concepts defined in the following claims also fall within the scope of the claims. Therefore, the true technical protection scope of the disclosure should be determined by the technical spirit of the appended claims.

What is claimed is:

1. An image decoding method performed by a decoding apparatus, the method comprising:
obtaining image information including intra prediction related information;
deriving an intra prediction mode for a chroma block based on the intra prediction related information;
deriving a luma block corresponding to the chroma block;
deriving at least one coefficient for the chroma block; and
deriving a prediction sample of the chroma block based on the luma block and the at least one coefficient,
wherein the at least one coefficient is derived based on neighboring reference samples of the chroma block.

2. The image decoding method of claim 1,
wherein the chroma block includes a chroma sample, and
wherein the luma block includes a luma sample corresponding to the chroma sample.

3. The image decoding method of claim 2,
Wherein the luma block includes at least one of a left sample, a top sample, a right sample, a bottom sample, a top-left sample, a top-right sample, a bottom-left sample, or a bottom-right sample of the luma sample.

4. The image decoding method of claim 2,
wherein a prediction sample of the chroma block is derived by applying an n-tap filter to at least one of a left sample, a top sample, a right sample, a bottom sample, a top-left sample, a top-right sample, a bottom-left sample, or a bottom-right sample of the luma sample.

5. The image decoding method of claim 3,
wherein a first sample value is derived based on a left sample and a right sample of the luma sample,
wherein a second sample value is derived based on a top sample and a bottom sample of the luma sample,
wherein a third sample value is derived based on the left sample and the right sample of the luma sample,
wherein a fourth sample value is derived based on the top sample and the bottom sample of the luma sample, and
wherein a fifth sample value is derived based on the luma sample, the left sample of the luma sample, the top sample of the luma sample, the right sample of the luma sample, and the bottom sample of the luma sample, and
wherein the prediction sample of the chroma block is derived based on the first sample value, the second sample value, the third sample value, the fourth sample value, and the fifth sample value.

6. The image decoding method of claim 3,
wherein the first sample value is derived based on a difference between a value of a left sample and a value of a right sample of the luma sample,
wherein the second sample value is derived based on a difference between a value of a top sample and a value of a bottom sample of the luma sample,
wherein the third sample value is derived based on a sum of the value of the left sample and the value of the right sample of the luma sample,
wherein the fourth sample value is derived based on a sum of the value of the top sample and the value of the bottom sample of the luma sample,
wherein the fifth sample value is derived based on a median value of the value of the luma sample, the value of the left sample of the luma sample, the value of the top sample of the luma sample, the value of the right sample of the luma sample, and the value of the bottom sample of the luma sample, and
wherein the prediction sample of the chroma block is derived based on the first sample value, the second sample value, the third sample value, the fourth sample value, and the fifth sample value.

7. The image decoding method of claim 6,
wherein the prediction sample of the chroma block is derived based on the following equation:
$$predChroma = w 0 * a + w 1 * b + w 2 * c + w 3 * d + w 4 * e ,$$
wherein a represents the first sample value, b represents the second sample value, c represents the third sample value, d represents the fourth sample value, e represents the fifth sample value, and w0, w1, w2, w3, and w4 represent the at least one coefficient.

8. The image decoding method of claim 6,
wherein a modified first sample value is derived based on the first sample value and a luma offset value,
wherein a modified second sample value is derived based on the second sample value and the luma offset value,
wherein a modified third sample value is derived based on the third sample value and the luma offset value,
wherein a modified fourth sample value is derived based on the fourth sample value and the luma offset value, and
wherein a modified fifth sample value is derived based on the fifth sample value and the luma offset value, and
wherein the prediction sample of the chroma block is derived based on the modified first sample value, the modified second sample value, the modified third sample value, the modified fourth sample value, the modified fifth sample value, and a chroma offset value.

9. The image decoding method of claim 1, further comprising deriving at least one neighboring reference sample line of the chroma block,
wherein the at least one coefficient is derived based on the at least one neighboring reference sample line.

10. The image decoding method of claim 9,
wherein a number of the at least one reference sample line is determined based on at least one of a size of the chroma block, a shape of the chroma block, an intra prediction mode, a partition type, a partition depth, or a color format.

11. The image decoding method of claim 9,
wherein the intra prediction mode is one of a first mode, a second mode, or a third mode, wherein when the intra prediction mode is the first mode the at least one coefficient is derived based on a top neighboring reference sample region, a left neighboring reference sample region, and a top-left neighboring reference sample region of the chroma block,
wherein when the intra prediction mode is the second mode the at least one coefficient is derived based on the top neighboring reference sample region of the chroma block, and
wherein when the intra prediction mode is the third mode the at least one coefficient is derived based on the left neighboring reference sample region of the chroma block.

12. The image decoding method of claim 11,
wherein the image information includes information indicating whether the intra prediction mode is the first mode, the second mode, or the third mode.

13. The image decoding method of claim 1,
wherein the image information includes information indicating whether the prediction sample of the chroma block is derived based on the luma block.

14. The image decoding method of claim 1, further comprising downsampling the luma block,
wherein the downsampled luma block includes a luma sample corresponding to the chroma sample.

15. The image decoding method of claim 14,
wherein the downsampled luma block includes at least one of a left sample, a top sample, a right sample, a bottom sample, a top-left sample, a top-right sample, a bottom-left sample, or a bottom-right sample of the luma sample.

16. An image encoding method performed by an encoding apparatus, the method comprising:
determining an intra prediction mode for a chroma block;
deriving a luma block corresponding to the chroma block;
deriving at least one coefficient for the chroma block;
deriving a prediction sample of the chroma block based on the luma block and the at least one coefficient; and
encoding image information including intra prediction mode related information,
wherein the at least one coefficient is derived based on neighboring reference samples of the chroma block.

17. The image encoding method of claim 16,
wherein the chroma block includes a chroma sample or chroma samples,
wherein the luma block includes a luma sample or luma samples corresponding to the chroma sample or chroma samples.

18. The image encoding method of claim 16,
wherein the luma block includes at least one of a left sample, a top sample, a right sample, a bottom sample, a top-left sample, a top-right sample, a bottom-left sample, or a bottom-right sample of the luma sample.

19. The image encoding method of claim 18,
wherein a first sample value is derived based on a left sample and a right sample of the luma sample,
wherein a second sample value is derived based on a top sample and a bottom sample of the luma sample,
wherein a third sample value is derived based on the left sample and the right sample of the luma sample,
wherein a fourth sample value is derived based on the top sample and the bottom sample of the luma sample,
wherein a fifth sample value is derived based on the luma sample, the left sample of the luma sample, the top sample of the luma sample, the right sample of the luma sample, and the bottom sample of the luma sample, and
wherein the prediction sample of the chroma block is derived based on the first sample value, the second sample value, the third sample value, the fourth sample value, and the fifth sample value.

20. A transmitting method for image data, the method comprising:
obtaining a bitstream generated by an image encoding method, wherein the bitstream is generated based on determining an intra prediction mode for a chroma block, deriving a luma block corresponding to the chroma block, deriving at least one coefficient for the chroma block, deriving a prediction sample of the chroma block based on the luma block and the at least one coefficient, and encoding image information including intra prediction mode related information; and
transmitting the image data including the bitstream,
wherein the at least one coefficient is derived based on neighboring reference samples of the chroma block.
